(19) United States
(12) Patent Application Publication
(10) Pub. No.: US 2024/0329991 A1
(43) Pub. Date: Oct. 3, 2024

(54) INSTRUCTIONS FOR FLOATING POINT MULTIPLICATION AND ADDITION AND CONVERSION EMPLOYING VARIABLE PRECISION

(71) Applicant: Intel Corporation, Santa Clara, CA (US)

(72) Inventors: Martin LANGHAMMER, Alderbury (GB); Alexander F. HEINECKE, San Jose, CA (US)

(21) Appl. No.: 18/194,327

(22) Filed: Mar. 31, 2023

(51) Int. Cl. G06F 9/30

(52) U.S. Cl. CPC G06F 9/30145; G06F 9/3001; G06F 9/30025

(57) ABSTRACT

An apparatus of an aspect includes decoder circuitry to decode an instruction. The instruction to indicate at least one source floating-point vector, a destination storage location, and at least one value. The source floating-point vector is to have floating-point data elements. The at least one value is to indicate at least one of: (a) a number of significand bits of the floating-point data elements; (b) a number of exponent bits of the floating-point data elements; (c) exponent bias information for the floating-point data elements; or (d) any combination thereof. Execution circuitry coupled with decoder circuitry is to perform operations according to the instruction. The operations include to interpret the floating-point data elements consistent with the at least one value, perform an operation specified by the instruction on the at least one source floating-point vector to generate a result vector, and store the result vector in the destination storage location.

### BACKGROUND

### Technical Field

Embodiments described herein generally relate to processors. In particular, embodiments described herein generally relate to processors to process floating-point data elements.

### Background Information

Floating-point numbers are commonly used in processors, computer systems, and other electronic devices. One advantage of floating-point numbers is that they allow a relatively wide range of numerical values to be represented in a relatively compact format and/or number of bits.

Floating-point numbers are defined according to a floating-point format. The floating-point format apportions the bits used to represent the floating-point number into several constituent fields known as the sign, the significant (also known as mantissa or fraction), and the exponent of the floating-point number. An exponent bias is also typically used to adjust the exponent. The value of the floating-point number may be expressed in terms of the sign “s”, the “significand”, the “exponent”, and the exponent bias “bias” as shown by the following equation:

$$value = {( - 1 )}^{s} * ( 1 + significand ) * {2}^{( exponent - bias )} \qquad Equation 1$$

The expression “(−1)^{s}” represents negative one raised to the power of the sign bit(s). This expression evaluates whether the floating-point number is positive or negative. For example, when the sign bit is zero the floating-point number is positive and when the sign bit is one the floating-point number is negative. The significand includes a string of bits of a length that affects the precision of the floating-point number. As shown by the expression “(1+significand)” the significand typically includes an implicit most significant or leftmost bit with a value of one known as the J-bit. This implicit bit is not one of the explicit bits of the floating-point number but rather is an implicit or hidden bit that provides additional precision without needing to explicitly encode another explicit significand bit. The binary point is commonly implicitly assumed to reside at a fixed position just to the right or one bit less significant than the J-bit.

The multiplication by two to the power of “(exponent-bias)” is used to shift the binary point by the exponent less the exponent bias. The exponent bias is used to control which encodings of the exponent bits represent values greater than one and which encodings of the exponent bits represent values between zero and one. The exponent bits are used to encode unsigned integers of different values. The subtraction of the exponent bias from the exponent may allow “exponent-bias” to be either positive or negative depending upon the value of the exponent and the exponent bias. The exponent biases for standard floating-point formats are typically standardized (fixed) for the format, and the standardized exponent biases often have values that map approximately equal numbers of exponent encodings to values greater than one and values between zero and one.

### BRIEF DESCRIPTION OF THE DRAWINGS

Various examples in accordance with the present disclosure will be described with reference to the drawings, in which:

FIG. 1 is a table listing several examples of standard floating-point formats and an embodiment of an adjustable floating-point format instruction.

FIG. 2 illustrates examples of computing hardware to process an adjustable floating-point format instruction.

FIG. 3 is a table listing several examples of adjustable floating-point formats.

FIG. 4 is a table listing several additional examples of adjustable floating-point formats.

FIG. 5 is a block diagram of an embodiment of a processor a floating-point control register having one or more fields to store at least one value to adjust a floating-point format for an adjustable floating-point format instruction.

FIG. 6 is a block diagram of an embodiment of a processor having a general-purpose register having one or more fields to store at least one value to adjust a floating-point format for an adjustable floating-point format instruction.

FIG. 7 is a block diagram of an embodiment of an adjustable floating-point format instruction having an immediate having one or more fields to store at least one value to adjust a floating-point format.

FIG. 8 illustrates an example method performed by a processor to process an adjustable floating-point format instruction.

FIG. 9 illustrates an example method to process an adjustable floating-point format instruction using emulation or binary translation.

FIG. 10 is a block diagram of an example embodiment of an instruction format for an adjustable floating-point format instruction.

FIG. 11 illustrates example circuitry to calculate exponents for multiplication of floating-point numbers with adjustable numbers of exponent bits.

FIG. 12 illustrates example exception and error range masking circuitry.

FIG. 13 illustrates example mantissa exception and error range masking circuitry.

FIG. 14 illustrates example circuitry for adjustable precision mantissa rounding.

FIG. 15 illustrates an example computing system.

FIG. 16 illustrates a block diagram of an example processor and/or System on a Chip (SoC) that may have one or more cores and an integrated memory controller.

FIG. 17 (A) is a block diagram illustrating both an example in-order pipeline and an example register renaming, out-of-order issue/execution pipeline according to examples.

FIG. 17 (B) is a block diagram illustrating both an example in-order architecture core and an example register renaming, out-of-order issue/execution architecture core to be included in a processor according to examples.

FIG. 18 illustrates examples of execution unit(s) circuitry.

FIG. 19 is a block diagram of a register architecture according to some examples.

FIG. 20 illustrates examples of an instruction format.

FIG. 21 illustrates examples of an addressing information field.

FIG. 22 illustrates examples of a first prefix.

FIGS. 23 (A)-(D) illustrate examples of how the R, X, and B fields of the first prefix in FIG. 22 are used.

FIGS. 24 (A)-(B) illustrate examples of a second prefix.

FIG. 25 illustrates examples of a third prefix.

FIG. 26 is a block diagram illustrating the use of a software instruction converter to convert binary instructions in a source instruction set architecture to binary instructions in a target instruction set architecture according to examples.

### DETAILED DESCRIPTION OF EMBODIMENTS

Disclosed herein are embodiments of floating-point instructions, embodiments of processors to perform the floating-point instructions, embodiments of methods performed by the processors when performing the floating-point instructions, embodiments of systems incorporating one or more processors to perform the floating-point instructions, and embodiments of programs or machine-readable mediums storing or otherwise providing the floating-point instructions. In the following description, numerous specific details are set forth (e.g., specific floating-point formats, instruction operations, processor configurations, sequences of operations, etc.). However, embodiments may be practiced without these specific details. In other instances, well-known circuits, structures and techniques have not been shown in detail to avoid obscuring the understanding of the description.

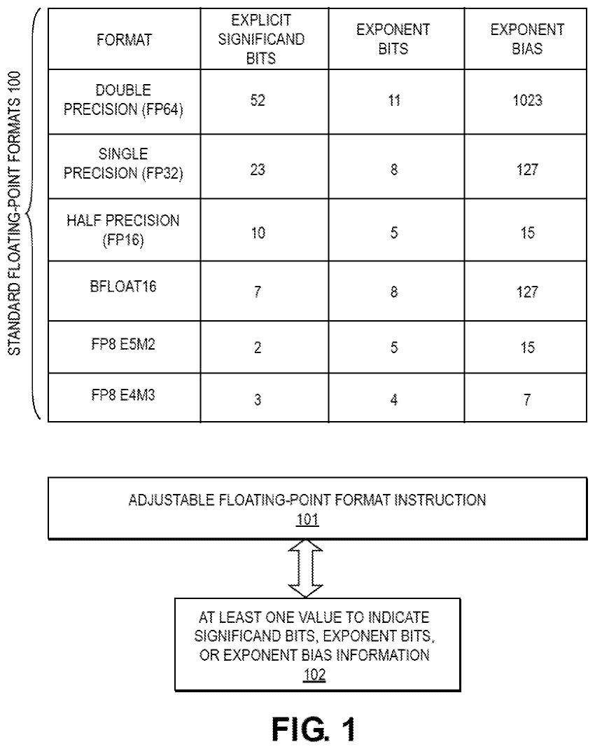

FIG. 1 is a table listing several examples of standard floating-point formats 100 and an embodiment of an adjustable floating-point format instruction 101. The number of explicit significand bits, the number exponent bits, and the exponent biases are listed in columns for the standard floating-point formats. A double-precision floating-point format (sometimes called FP64) is a 64-bit format that includes 1 sign bit, 53 significand bits (52 of which are explicit and 1 of which is implicit), and 11 exponent bits, and that uses a standardized exponent bias of 1023. A single-precision floating-point format (sometimes called FP32) is a 32-bit format that includes 1 sign bit, 24 significand bits (23 of which are explicit and 1 of which is implicit), and 8 exponent bits, and that uses a standardized exponent bias of 127. A half-precision floating-point format (sometimes called FP16) is a 16-bit format that includes 1 sign bit, 11 significand bits (10 of which are explicit and 1 of which is implicit), and 5 exponent bits, and that uses a standardized exponent bias of 15. A bfloat16 or bf16 floating-point format is a 16-bit format that includes 1 sign bit, 8 significand bits (7 of which are explicit and 1 of which is implicit), and 8 exponent bits, and that uses a standardized exponent bias of 127. An FP8 E5M2 format is an 8-bit format that includes 1 sign bit, 3 significand bits (2 of which are explicit and 1 of which is implicit), and 5 exponent bits, and that uses a standardized exponent bias of 15. An FP8 E4M3 format is an 8-bit format that includes 1 sign bit, 4 significand bits (3 of which are explicit and 1 of which is implicit), and 4 exponent bits, and that uses a standardized exponent bias of 7. Other standard floating-point formats are also known, such as, for example, extended double-precision floating-point format, tensor float 32 floating-point format (sometimes called TF32), as well as floating-point formats with less than 8-bits (e.g., 4-bit log-based formats). TF32 is a floating-point format that is not byte aligned and has 1 sign bit, 11 significand bits (10 of which are explicit and 1 of which is implicit), and 8 exponent bits, and that uses a standardized exponent bias of 127.

Different floating-point formats tend to be more useful or appropriate for different types of applications or uses. The different formats provide different precisions, different ranges, different numbers of bits that need to be loaded from memory and stored, and so on. As a result, over the years new and different floating-point formats have been standardized. For example, the bfloat16, FP8 E5M2, and FP8 E4M3 formats are relatively more recently adopted formats for such applications as artificial intelligence, machine learning, and the like. Moreover, it is expected that even more new floating-point formats may be developed in the future. For example, artificial intelligence, machine learning, and like applications are relatively new and are still developing. There is a chance that the formats best suited for such applications may change one or more times as these applications develop.

A challenge therefore arises as to how to design processors and their instruction sets to support such different floating-point formats. One possible approach is to add a number of new instructions to the instruction set to support each of these floating-point formats as the floating-point formats become sufficiently important. The floating-point format is essentially fixed for these instructions and the handling of the floating-point format is designed into the processor for these instructions. However, adding these instructions to the instruction set has a cost, generally takes time, and introduces a risk of introducing instructions that may become obsolete if the floating-point format becomes obsolete.

Referring again to FIG. 1, an embodiment of an adjustable floating-point format instruction 101 is shown. The adjustable floating-point format instruction may have, indicate, or otherwise provide at least one value 102 to indicate at least one of: (a) a number of significand bits of the floating-point data elements; (b) a number of exponent bits of the floating-point data elements; and (c) exponent bias information for the floating-point data elements. Advantageously, although the adjustable floating-point format instruction may be capable of indicating standardized floating-point formats, in some embodiments it is not limited to indicating a single standardized floating-point format, or even several standardized floating-point formats, but rather may be able to indicate new and/or non-standardized floating-point formats, through flexible or adjustable specification of different numbers of significand bits and/or exponent bits and/or exponent bias information.

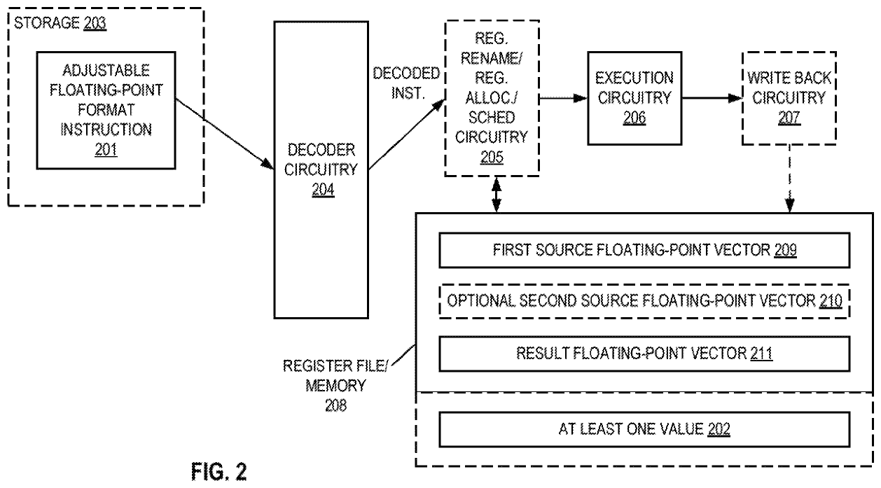

FIG. 2 illustrates examples of computing hardware to process an adjustable floating-point format adjustable floating-point format instruction 201. The instruction may represent a macroinstruction, machine code instruction, or instruction of an instruction set of a processor. As illustrated, optional storage 203 may store the adjustable floating-point format instruction to be executed. By way of example, the storage may be a cache (e.g., an instruction cache, a unified cache) or memory.

In some embodiments, the computing hardware may be included in a general-purpose processor (e.g., a general-purpose microprocessor or central processing unit (CPU) of the type used in desktop, laptop, or other computers). Alternatively, the computing hardware may be included in a special-purpose processor. Examples of suitable special-purpose processors include, but are not limited to, co-processors, machine-learning processors, artificial intelligence processors, graphics processors, digital signal processors (DSPs), and controllers (e.g., microcontrollers). The processor may have any of various complex instruction set computing (CISC) architectures, reduced instruction set computing (RISC) architectures, very long instruction word (VLIW) architectures, hybrid architectures, other types of architectures, or have a combination of different architectures (e.g., different cores may have different architectures). In some embodiments, the processor may include (e.g., be disposed on) at least one integrated circuit or semiconductor die.

The instruction 201 is received by decoder circuitry 204. For example, the decoder circuitry may be coupled with the storage via an optional fetch circuitry (not shown) to receive the instruction. The instruction includes one or more fields for an opcode. In some examples, the opcode specifies the operation of the instruction to be performed, such as, for example, to use one or more values to understand how to interpret floating-point data elements and perform an operation on the floating-point data elements. Examples of suitable operations include, but are not limited to, vector addition, vector multiplication, vector fused multiplication and addition, vector floating-point format conversion, and other operations mentioned further below.

The instruction may explicitly specify (e.g., through one or more fields or a set of bits), or otherwise indicate (e.g., implicitly indicate), a first source floating-point vector 209 having floating-point data elements. In some embodiments the instruction may optionally specify or otherwise indicate an optional second source floating-point vector 210 having floating-point data elements. The instruction may specify or otherwise indicate a destination storage location 212 where a result floating-point vector 211 is to be stored. As one example, the instruction may have source and/or destination fields or identifiers to specify or otherwise indicate registers, memory locations, or other storage locations for these vectors. Alternatively, one or more of these registers, memory locations, or other storage locations may optionally be implicit to the instruction (e.g., implicit to the opcode). For example, a source/destination register may be implicitly or impliedly understood to be used for both a source operand and a result operand. In various embodiments, the vectors may be 64-bit, 128-bit, 256-bit, 512-bit, 1024-bit, or even wider vectors. In various embodiments, the floating-point data elements may be 4-bit, 8-bit, 16-bit, 32-bit, or 64-bit floating-point data elements.

The instruction may also specify or otherwise indicate at least one value 202. In some embodiments, the at least one value may indicate at least one of: (a) a number of significand bits of the floating-point data elements of the first source floating-point vector 209; (b) a number of exponent bits of the floating-point data elements of the first source floating-point vector 209; and (c) exponent bias information for the floating-point data elements of the first source floating-point vector 209. The number of significand bits may either be the number of explicit significant bits explicitly encoded in the floating-point data elements or may include the implicit bit or J-bit. The exponent bias information may be an actual exponent bias, an exponent bias offset relative to a standard, expected, or reference exponent bias (e.g., indicating to add an integer offset number to the reference exponent bias), or other exponent bias information capable of indicating an exponent bias (e.g., an index to select one of a set of predetermined exponent biases).

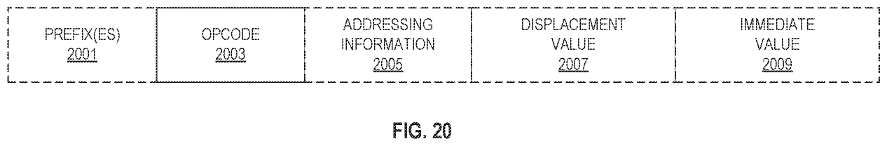

The instruction may be in any suitable format, such as that describe with reference to FIG. 20 below. More detailed examples of at least one instruction format for the instruction will be detailed later. The decoder circuitry 204 may decode the instruction into one or more lower-level control signals or operations. In some examples, this decoding includes generating a plurality of micro-operations to be performed by execution circuitry (such as execution circuitry 206). For some instruction encodings, the decoder circuitry may also optionally decode instruction prefixes. In some embodiments, the decoder circuitry may include at least one input structure (e.g., a port, interconnect, or interface) coupled to receive the instruction, an instruction recognition and decode circuitry coupled therewith to recognize and decode the instruction, and at least one output structure (e.g., a port, interconnect, or interface) coupled therewith to output the one or more operations or decoded instructions. The instruction recognition and decode circuitry may be implemented using various approaches including, but not limited to, microcode read only memories (ROMs), look-up tables, hardware implementations, programmable logic arrays (PLAs), other mechanisms suitable to implement decode circuitry, and combinations thereof. In some embodiments, the decode circuitry may be included on a die, integrated circuit, or semiconductor substrate.

In some examples, optional register renaming, register allocation, and/or scheduling circuitry 205 may provide functionality for one or more of: (1) renaming logical operand values to physical operand values (e.g., a register alias table in some examples); (2) allocating status bits and flags to the decoded instruction; and (3) scheduling the decoded instruction for execution by execution circuitry out of an instruction pool (e.g., using a reservation station in some examples).

Registers (e.g., a register file) and/or memory 208 may store the vectors or operands of the instruction to be operated by execution circuitry 206. As shown in dashed lines, in some embodiments, the at least one value 202 may optionally be stored in the registers and/or memory 208. These registers may represent on-die (or on integrated circuit) storage locations to store data. These registers may represent architectural registers or architecturally-visible registers that are visible to software and/or a programmer and/or are the registers indicated by instructions of the instruction set of the processor to identify operands. These architectural registers are contrasted to non-architectural registers in a microarchitecture (e.g., temporary registers, reorder buffers, retirement registers, etc.). The registers may be implemented in different ways in different microarchitectures and are not limited to any particular type of design. Examples of suitable types of registers include, but are not limited to, dedicated physical registers, dynamically allocated physical registers using register renaming, and combinations thereof. Example register types include packed data or vector registers, general purpose registers (GPRs), and floating-point registers.

Execution circuitry 206 is coupled with the decode circuitry 204 to receive the one or more operations and/or the decoded instruction(s). The execution circuitry is also coupled with the registers and/or memory 208 to receive the first and optional second source floating-point vectors and to store the result floating-point vector. The execution circuitry is to execute the one or more operations and/or the decoded instruction(s) to perform operations corresponding to or as specified by the instruction.

In some embodiments, the execution circuitry 206 may interpret the floating-point data elements of the first source floating-point vector 209, and in some cases also the floating-point data elements of the optional second source floating-point vector, consistent with the at least one value 202. For example, this may include interpreting the floating-point data elements consistent with an exponent bias indicated by the at least one value and/or interpreting the floating-point data elements consistent with a number of exponent bits and/or significand bits indicated by the at least one value. The at least one value may further define or explain the format of the floating-point data elements and therefore how to interpret the encoded bits and give numerical values to the floating-point data elements. In some embodiments, the interpretation of the floating-point data elements is not based merely on the opcode of the instruction but also based at least in part on the at least one value 202.

In some embodiments, the at least one value 202 may indicate at least the exponent bias information. The exponent bias information may be an actual exponent bias, an exponent bias offset relative to a standard, expected, or reference exponent bias (e.g., indicating to add an integer offset number to the reference exponent bias), or other exponent bias information capable of indicating an exponent bias (e.g., an index to select one of a set of predetermined exponent biases). Conventionally, instructions do not indicate exponent bias information. Conventionally, instructions may have an opcode that indicates a standard floating-point format, and the processors may have circuitry designed to support the standard floating-point format including the standardized exponent bias for that format. However, the instructions do not indicate the exponent bias information directly other than indirectly indicating a standard floating-point format through the opcode. Also, the conventional instructions do not allow for altering a standardized exponent bias.

In contrast, in some embodiments, the adjustable floating-point format instruction 201 may indicate the at least one value 202 having the exponent bias information, such as, for example, a value (e.g., two, three, four, five, six, seven, eight, or more bits) that specifies an exponent bias or exponent bias offset. In various embodiments, the at least one value 202 may allow specification or indication of at least five, ten, fifteen, or more different exponent biases or exponent bias offsets (e.g., at least five, ten, fifteen, or more different numerical values) to be used for processing the floating-point numbers, even when the floating-point numbers have a given total width in bits (e.g., of 8-bits, 16-bits, 32-bits, etc.).

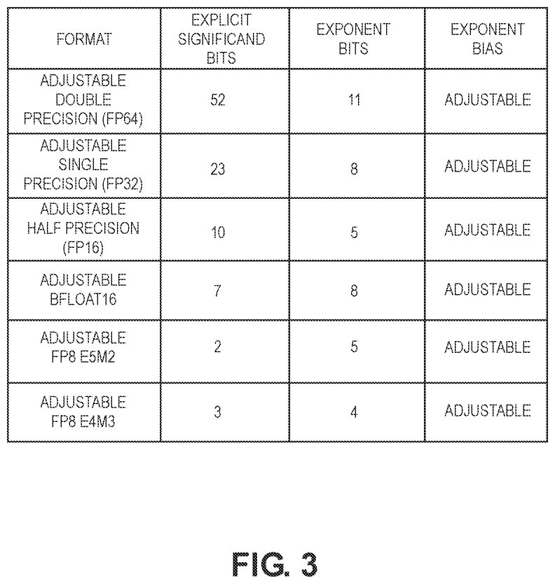

FIG. 3 is a table listing several examples of adjustable floating-point formats. The number of explicit significand bits, the number exponent bits, and the exponent biases are listed in columns for the adjustable floating-point formats. In some embodiments, the adjustable floating-point format instruction 201 may indicate that any one or more of these adjustable floating-point formats be used for source and/or destination floating-point vectors, and may indicate at least one value of exponent bias information to make these adjustable floating-point formats have an adjustable exponent bias (e.g., that may be adjusted to either be the same as or different than the standardized exponent bias for the format).

A first row describes an adjustable 64-bit double-precision floating-point data element format, which has 11 exponent bits, and 52 explicit significand bits, and an adjustable exponent bias, which may be adjusted by the exponent bias information, to either be the same or different than the standardized exponent bias of 1023 for the double-precision floating-point data element format. A second row describes an adjustable 32-bit single-precision floating-point data element format, which has 8 exponent bits, and 23 explicit significand bits, and an adjustable exponent bias, which may be adjusted by the exponent bias information, to either be the same or different than the standardized exponent bias of 127 for the single-precision floating-point data element format. A third row describes an adjustable 16-bit half-precision floating-point data element format, which has 5 exponent bits, and 10 explicit significand bits, and an adjustable exponent bias, which may be adjusted by the exponent bias information, to either be the same or different than the standardized exponent bias of 15 for the half-precision floating-point data element format.

A fourth row describes an adjustable 16-bit bfloat16 floating-point data element format, which has 8 exponent bits, and 7 explicit significand bits, and an adjustable exponent bias, which may be adjusted by the exponent bias information, to either be the same or different than the standardized exponent bias of 127 for the bfloat 16 floating-point data element format. A fifth row describes an adjustable 8-bit FP8 E5M2 floating-point data element format, which has 5 exponent bits, and 2 explicit significand bits, and an adjustable exponent bias, may be adjusted by the exponent bias information, to either be the same or different than the standardized exponent bias of 15 for the FP8 E5M2 floating-point data element format. A sixth row describes an adjustable 8-bit FP8 E4M3 floating-point data element format, which has 4 exponent bits, and 3 explicit significand bits, and an adjustable exponent bias, which may be adjusted by the exponent bias information, to either be the same or different than the standardized exponent bias of 7 for the FP8 E4M3 floating-point data element format. These are just a few examples. Another example is an adjustable TF32 floating-point format, which has, which has 8 exponent bits, and 10 explicit significand bits, and an adjustable exponent bias, which may be adjusted by the exponent bias information, to either be the same or different than the standardized exponent bias of 127 for the TF32 floating-point data element format.

In some embodiments, except for the possible indication of the non-standardized exponent bias, the floating-point data element formats may otherwise be and/or conform to the respective standard floating-point formats of double-precision, single-precision, half-precision, bfloat16, FP8 E5M2, or FP8 E4M3. One possible advantage of providing such exponent bias information via the adjustable floating-point format instruction is that for certain applications, data processing, or usages it may be better for some reason to adjust the exponent bias used to interpret and process the floating-point numbers. For example, this may allow redistributing or reallocating the numbers of exponent encodings mapped to the range of one to infinity versus those mapped to the range of zero to one relative to the fixed allocations for the standard exponent biases. This may allow programmers or applications to use the adjustable floating-point format instruction to indicate non-standard exponent biases when they are better in some way for some application or usage.

In other embodiments, the at least one value 202 may include a first value and a second value, and the first and second values may indicate any two of: (a) a number of significand bits of the floating-point data elements of the first source floating-point vector 209; (b) a number of exponent bits of the floating-point data elements of the first source floating-point vector 209; and (c) a total number of bits of the floating-point data elements of the first source floating-point vector 209 (e.g., 8-bits, 16-bits, 32-bits, 64-bits, etc.). In still other embodiments, the at least one value 202 may include a first value, a second value, and a third value, and the first, second, and third values may indicate any three of (a) a number of significand bits of the floating-point data elements; (b) a number of exponent bits of the floating-point data elements; (c) exponent bias information for the floating-point data elements; and (d) a number of bits of the floating-point data elements. The number of significand bits may either be the number of explicit significant bits explicitly encoded in the floating-point data elements or may include the implicit bit or J-bit.

The first and second values may indicate how the bits of the floating-point data elements are to be interpreted and processed, such as how many bits are allocated for the exponent versus how many are allocated for the significand. As one example, the first value may specify the number of significand bits and the second value may specify the number of exponent bits and the total number of bits may be determinable from the number of significand bits and the number of exponent bits (e.g., by adding them and adding one for the sign bit). As another example, the first value may specify the total number of bits and the second value may specify the number of exponent bits and the number of significand bits may be determinable from the total number of bits and the number of exponent bits (e.g., by subtracting the number of exponent bits and one for the sign bit from the total number of bits).

Conventionally, instructions do not indicate first and second values to indicate two of these characteristics. Conventionally, instructions may have an opcode that indicates a standard floating-point format, and the processors may have circuitry designed to support the standard floating-point format, including the standardized numbers of significand bits and the standardized number of exponent bits. However, the instructions do not indicate the numbers of significand bits or the numbers of exponent bits directly other than indirectly indicating a standard floating-point format through the opcode.

In contrast, in some embodiments, the adjustable floating-point format instruction 201 may indicate the first and second values (e.g., each having two, three, four, five, six, seven, eight, or more bits) that specify two of the number of significand bits, the number of exponent bits, and the total number of bits. In various embodiments, the first value may allow indication of at least five, ten, fifteen, or more different numbers of exponent bits (e.g., the first value be allowed to have at least five, ten, fifteen, or more different numerical values), even when the floating-point numbers have a given total number of bits (e.g., of 8-bits, 16-bits, 32-bits, etc.). In some embodiments, the first value may explicitly specify the number of exponent bits (e.g., have a value of 9 to indicate 9 exponent bits, etc.). In various embodiments, the first value may allow indication of at least five, ten, fifteen, or more different numbers of significand bits (e.g., the first value be allowed to have at least five, ten, fifteen, or more different numerical values), even when the floating-point numbers have a given total number of bits (e.g., of 8-bits, 16-bits, 32-bits, etc.). In some embodiments, the first value may explicitly specify the number of significand bits (e.g., have a value of 9 to indicate 9 explicit significand bits, etc.).

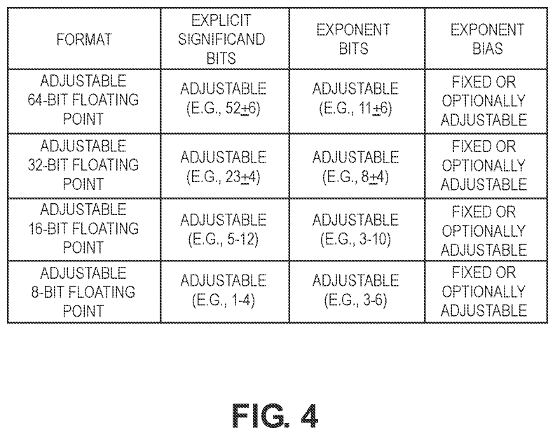

FIG. 4 is a table listing several examples of adjustable floating-point formats. The number of explicit significand bits, the number exponent bits, and the exponent biases are listed in columns for the adjustable floating-point formats. In some embodiments, the adjustable floating-point format instruction 201 may indicate that any one or more of these adjustable floating-point formats be used for source and/or destination floating-point vectors, and may indicate a first value and a second value that indicate any two of: (a) a number of significand bits; (b) a number of exponent bits; and (c) a total number of bits.

A first row describes an adjustable 64-bit floating-point data element format, which has an adjustable number of significand bits (e.g., 52+6), an adjustable number of exponent bits (e.g., 11+6), and either a fixed (e.g., fixed based on the number of exponent bits) or optionally adjustable exponent bias. A second row describes an adjustable 32-bit floating-point data element format, which has an adjustable number of significand bits (e.g., 23+4), an adjustable number of exponent bits (e.g., 8+4), and either a fixed (e.g., fixed based on the number of exponent bits) or optionally adjustable exponent bias. A third row describes an adjustable 16-bit floating-point data element format, which has an adjustable number of significand bits (e.g., from 5 to 12), an adjustable number of exponent bits (e.g., from 3 to 10), and either a fixed (e.g., fixed based on the number of exponent bits) or optionally adjustable exponent bias. A fourth row describes an adjustable 8-bit floating-point data element format, which has an adjustable number of significand bits (e.g., from 1 to 4), an adjustable number of exponent bits (e.g., from 3 to 6), and either a fixed (e.g., fixed based on the number of exponent bits) or optionally adjustable exponent bias. These are just a few examples. The same idea may also be applied to formats that are not byte aligned (e.g., a 19-bit floating-point format (e.g., akin to TF32) which may have an adjustable number of significand bits (e.g., from 5 to 12), an adjustable number of exponent bits (e.g., from 3 to 10), and either a fixed (e.g., fixed based on the number of exponent bits) or optionally adjustable exponent bias). By way of example, one possible way to fix the exponent bias based on the number of exponent bits is to fix the exponent bias to about the midpoint of the exponent value or to have the exponent bias be equal to (2^{(exponent bits-1)}−1).

Now, the at least one value has primarily been described in the context of the floating-point data elements of the first source floating-point vector 209. However, the same approach can be used for the floating-point data elements of the second source floating-point vector 210 or those of the result floating-point vector 211 (e.g., if either are to use a different floating-point format than those of the first source floating-point vector). In fact, it is possible to provide three different sets of one or more values where each of the three sets of one or more values corresponds to a different one of the vectors 209, 210, 211 so that different adjustable floating-point formats could be specified for each of these vectors.

One possible advantage of providing such adjustable exponent and significand bit information via the adjustable floating-point format instruction is that the instruction is not dedicated to or limited to a particular floating-point format but rather is at least somewhat agnostic to the numbers of exponent and significand bits. This may allow the instruction to be used for newly developed and/or non-standardized floating-point formats developed after the instruction is introduced into the instruction set.

Based on the interpretation of the floating-point data elements consistent with the at least one value 202, the execution circuitry 206 may perform an operation specified by the instruction on the at least one source floating-point vector (e.g., the first source floating-point vector), or in some cases on both the first source floating-point vector 209 and the second source floating-point vector 210, to generate the result floating-point vector 211. The execution circuitry 206 may also store the result floating-point vector in the destination storage location 212 indicated by the instruction.

Examples of suitable operations include, but are not limited to, vector addition, vector multiplication, vector fused multiplication and addition, vector floating-point format conversion, and other operations mentioned further below. These vector operations may either be masked/predicated or unmasked/unpredicated. By way of example, an unmasked vector operation may include performing an operation (e.g., addition, multiplication, etc.) on each pair of corresponding (e.g., in the same relative bit positions) floating-point data elements of the first and second source floating-point vectors to generate the result floating-point vector having the results of the operations (e.g., the sums of the corresponding pairs of floating-point data elements, the products of the corresponding pairs of floating-point data elements, etc.). The masked vector operation may be similar but may only be performed on those corresponding pairs of floating-point data elements for which a corresponding mask bit or mask element is unmasked or a has a first value as opposed to being masked or having a second value.

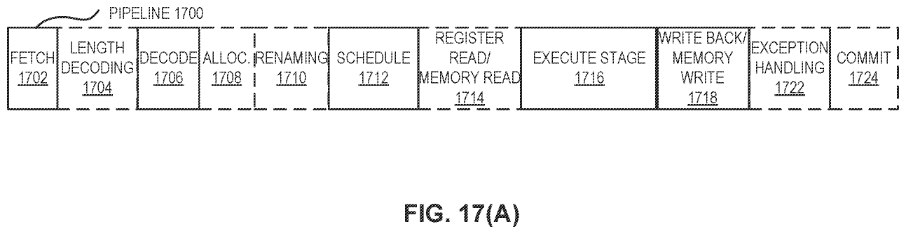

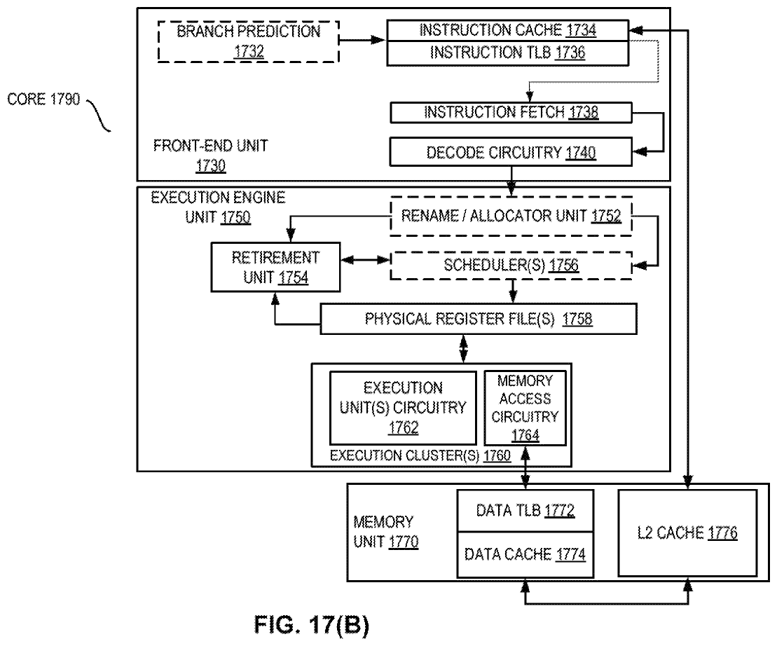

In some embodiments, the execution circuitry may be a floating-point unit, a floating-point arithmetic unit, a floating-point arithmetic logic unit, a floating-point multiplier, a floating-point adder, or the like. In some embodiments, the execution circuitry may include specific or particular logic to perform the instruction. By way of example, the execution circuitry may include floating-point element processing circuitry (e.g., exponent processing circuitry (e.g., an exponent adder), circuitry to subtract an exponent bias from an exponent, etc.). In some embodiments, the execution unit may include one or more input structures (e.g., a port, interconnect, or interface) coupled to receive the source data, circuitry coupled therewith to receive and process the source data and generate the result data, and one or more output structures (e.g., a port, interconnect, or interface) coupled therewith to output the result data. Other example execution circuitry includes execution cluster(s) 1760 shown in FIG. 17 (B), etc.

In some examples, optional retirement/write back circuitry 207 architecturally commits the destination register into the registers or memory 208 and retires the instruction.

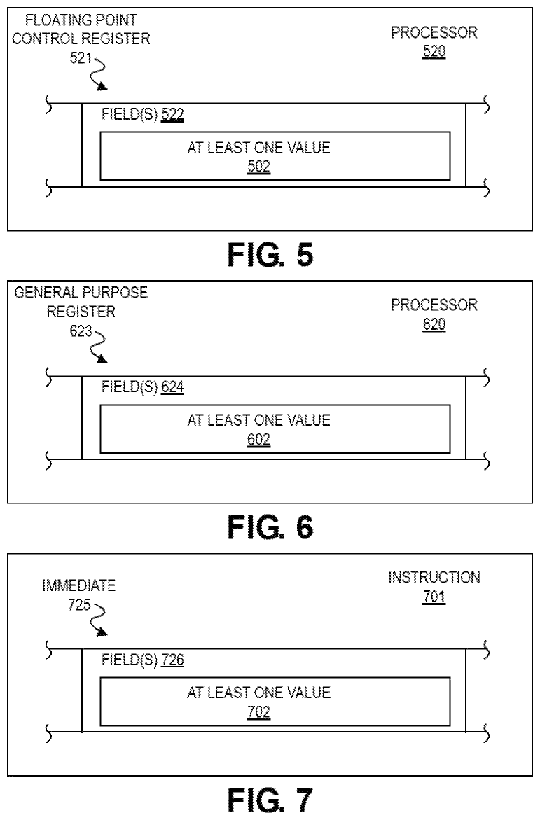

FIG. 5 is a block diagram of an embodiment of a processor 520 having a floating-point control register 521 having one or more fields 522 to store at least one value 502 (e.g., the at least one value 202) for an adjustable floating-point format instruction (e.g., the adjustable floating-point format instruction 201). Examples of suitable floating-point control registers include, but are not limited to, the MCSCR in Intel® Architecture and the Floating-point Control Register (FPCR) in Aarch64 of the ARM Architecture. Without limitation, the floating-point control register may also store other information to control floating point processing, such as, for example, rounding mode information, flush to zero information, denormal handling information, and the like. Storing the at least one value in the floating-point control register may provide thread-local control for a thread executing the adjustable floating-point format instruction. The floating-point control register may represent part of the execution state of the processor and may be saved and restored on context switches.

FIG. 6 is a block diagram of an embodiment of a processor 620 having a general-purpose register 623 having one or more fields 624 to store at least one value 602 (e.g., the at least one value 202) for an adjustable floating-point format instruction (e.g., the adjustable floating-point format instruction 201). By way of example, the general-purpose register may be an 8-bit, 16-bit, 32-bit, or 64-bit general-purpose register. When the general-purpose register is used, the adjustable floating-point format instruction may explicitly specify (e.g., have a field to specify) or otherwise indicate (e.g., implicitly indicate) that the general-purpose register is a source of the at least one value. This approach allows software to specify the at least one value at runtime by storing the at least one value in the general-purpose register. This may provide per-instruction or instruction-level control that is available at execution time and that may potentially cause the execution circuitry performing the instruction to be reconfigured for that particular instruction. This approach may help to avoid the at least one value being additional execution state to be saved and restored on context switches.

FIG. 7 is a block diagram of an embodiment of an adjustable floating-point format instruction 701 (e.g., the adjustable floating-point format instruction 201) having an immediate 725 having one or more fields 726 to store at least one value 702 (e.g., the at least one value 202). By way of example, the immediate may be a 4-bit, 8-bit, 16-bit, 32-bit, other sized immediate. This approach allows the at least one value to be fixed or specified at compile time. This may provide per-instruction or instruction-level control that is available prior to execution time (e.g., at decode time) and that may potentially cause the execution circuitry performing the instruction to be reconfigured for that particular instruction. This approach may help to avoid the at least one value being additional execution state to be saved and restored on context switches.

In some embodiments, the floating-point control register, the general-purpose register, or the immediate may have a field to store exponent bias information. In some embodiments, the floating-point control register, the general-purpose register, or the immediate may have a first field and a second field to store two different ones of a number of significand bits, a number of exponent bits, and a total number of bits of floating-point data elements. In some embodiments, the floating-point control register, the general-purpose register, or the immediate may have a first field, a second field, and a third field to store three different ones of exponent bias information, a number of significand bits, a number of exponent bits, and a total number of bits of floating-point data elements. Alternatively, such information may optionally be stored in any combination of the floating-point control register, the general-purpose register, or the immediate.

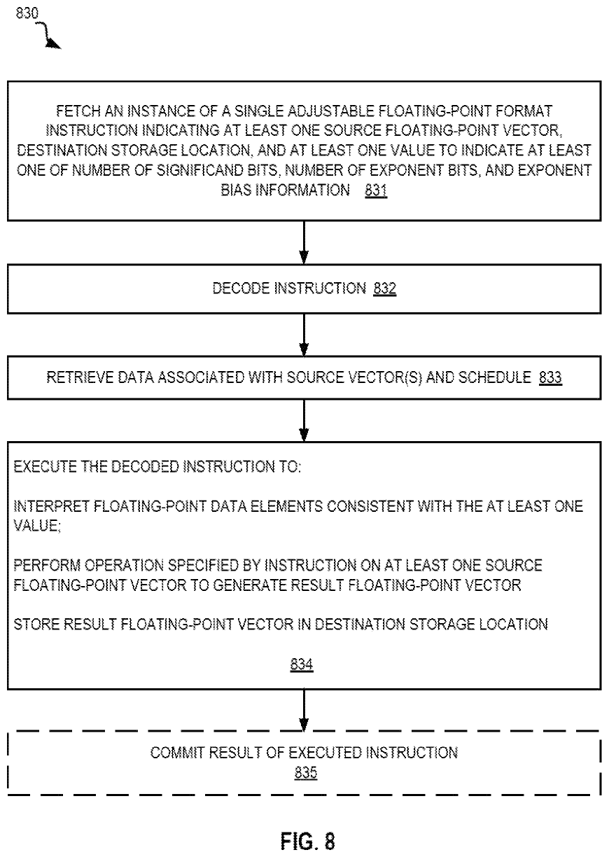

FIG. 8 illustrates an example embodiment of a method 830 performed by a processor to process an adjustable floating-point format instruction (e.g., the adjustable floating-point format instruction 201). For example, the computing hardware shown in FIG. 2, the processor core as shown in FIG. 17 (B), a pipeline as detailed below, etc., may perform this method. The components, features, and specific optional details described herein for the computing hardware shown in FIG. 2, the processor core as shown in FIG. 17 (B), a pipeline as detailed below, etc., also optionally apply to the method. Alternatively, the method may be performed by and/or within similar or different processors. Moreover, the computing hardware shown in FIG. 2 may perform methods the same as, similar to, or different than the method of FIG. 8.

At 831, an instance of single instruction is fetched. For example, an adjustable floating-point format instruction is fetched. In some examples, the instruction is fetched from an instruction cache. The instruction may explicitly specify, or otherwise indicate, a first source floating-point vector having floating-point data elements. In some embodiments the instruction may optionally specify or otherwise indicate an optional second source floating-point vector having floating-point data elements. The instruction may specify or otherwise indicate a destination storage location where a result floating-point vector is to be stored. These vectors and the ways they are indicated may be the same as what was previously described for FIG. 2.

In some embodiments, the instruction may also specify or otherwise indicate at least one value (e.g., the at least one value 202). In some embodiments, the at least one value to indicate at least one of: (a) a number of significand bits of the floating-point data elements; (b) a number of exponent bits of the floating-point data elements; and (c) exponent bias information for the floating-point data elements. In some embodiments, the at least one value may indicate the exponent bias information as previously described. In some embodiments, the at least one value may include at least two values or at least three values as previously described. In some embodiments, the at least two values may indicate any two of a number of significand bits, a number of exponent bits, and a total number of bits of the floating-point data elements of the first source floating-point vector, as previously described.

The fetched instruction may be decoded at 832. For example, the fetched adjustable floating-point format instruction may be decoded by decoder circuitry such as decoder circuitry 204 or decode circuitry 1740 detailed herein.

Floating-point data elements associated with the source vector(s) of the decoded instruction may be retrieved when the decoded instruction is scheduled at 833. For example, when one or more of the source operands are memory operands, the data from the indicated memory location may be retrieved.

At 834, the decoded instruction is executed by execution circuitry (hardware) such as execution circuitry 206 shown in FIG. 2, or execution cluster(s) 1760 shown in FIG. 17 (B). This may include performing operations according to the instruction. In some embodiments, these operations may include interpreting the floating-point data elements consistent with the at least one value (e.g., consistent with one or more of an indicated exponent bias, exponent bias offset, number of significand bits, number of exponent bits, etc.).

The operations may also include performing an operation specified by the instruction on the at least one source floating-point vector to generate a result floating-point vector. This may include handling the floating-point data elements consistent with the at least one value. Examples of suitable operations include, but are not limited to, vector addition, vector multiplication, vector fused multiplication and addition, vector floating-point format conversion, and other operations mentioned further below. These vector operations may either be masked/predicated or unmasked/unpredicated.

In some examples, the instruction is committed or retired at 835. This may cause the result floating-point vector may to be stored in the destination storage location (e.g., a renamed register committed to an architectural register).

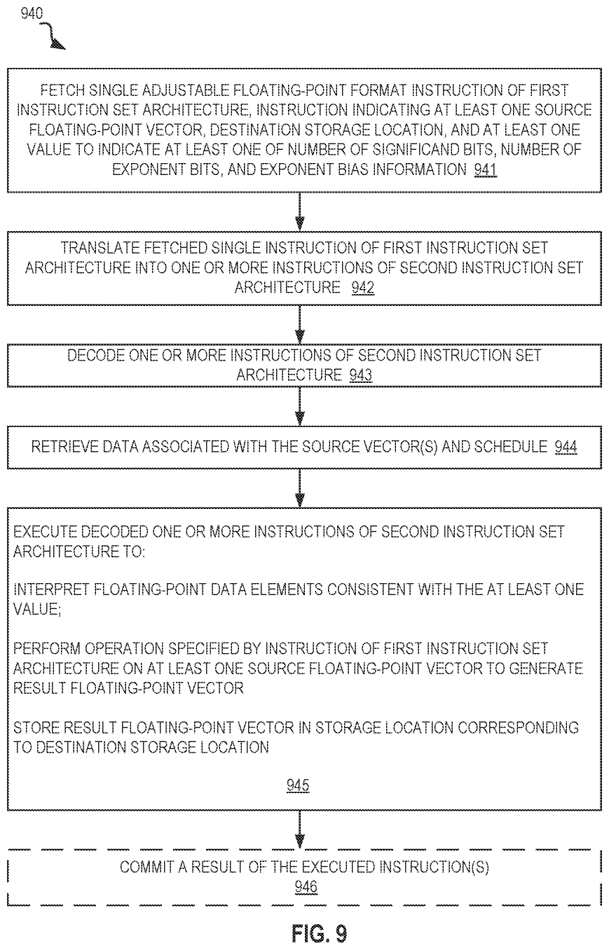

FIG. 9 illustrates an example embodiment of a method 940 to process an adjustable floating-point format instruction (e.g., the adjustable floating-point format instruction 201) using emulation or binary translation. For example, the computing hardware shown in FIG. 2, the processor core as shown in FIG. 17 (B), a pipeline as detailed below, etc., performs this method. The components, features, and specific optional details described herein for the computing hardware shown in FIG. 2, the processor core as shown in FIG. 17 (B), a pipeline as detailed below, etc. also optionally apply to the method. Alternatively, the method may be performed by and/or within similar or different processors. Moreover, the computing hardware of FIG. 2 may perform methods the same as, similar to, or different than the method of FIG. 9.

An instance of a single instruction of a first instruction set architecture is fetched at 941. For example, the adjustable floating-point format instruction is fetched (e.g., the adjustable floating-point format instruction 201). In some examples, the instruction is fetched from an instruction cache. The instruction may explicitly specify, or otherwise indicate, a first source floating-point vector having floating-point data elements. In some embodiments the instruction may optionally specify or otherwise indicate an optional second source floating-point vector having floating-point data elements. The instruction may specify or otherwise indicate a destination storage location where a result floating-point vector is to be stored. These vectors and the ways they are indicated may be the same as what was previously described for FIG. 2.

In some embodiments, the adjustable floating-point format instruction may also specify or otherwise indicate at least one value (e.g., the at least one value 202). In some embodiments, the at least one value to indicate at least one of: (a) a number of significand bits of the floating-point data elements; (b) a number of exponent bits of the floating-point data elements; and (c) exponent bias information for the floating-point data elements. In some embodiments, the at least one value may indicate the exponent bias information as previously described. In some embodiments, the at least one value may include at least two values or at least three values as previously described. In some embodiments, the at least two values may indicate any two of a number of significand bits, a number of exponent bits, and a total number of bits of the floating-point data elements of the first source floating-point vector, as previously described.

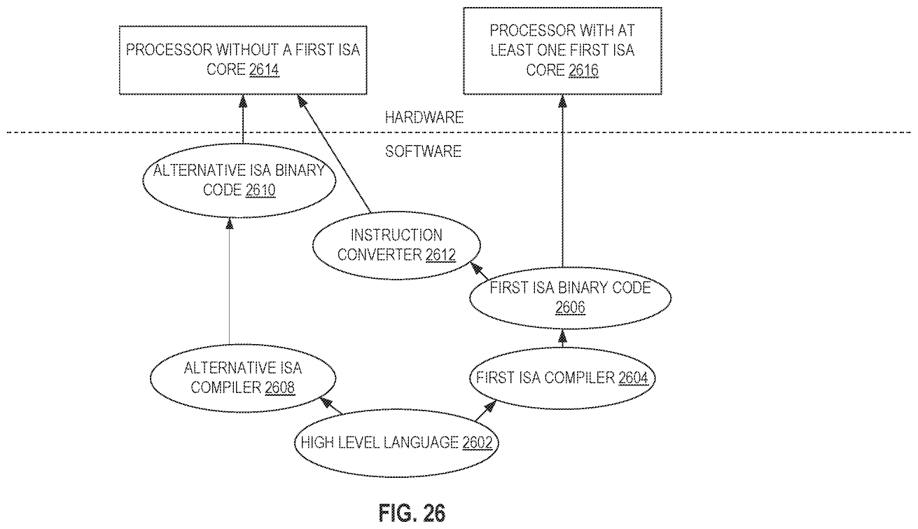

The fetched single instruction of the first instruction set architecture is translated into one or more instructions of a second instruction set architecture at 942. This translation is performed by a translation and/or emulation layer of software in some examples. In some examples, this translation is performed by an instruction converter 2612 as shown in FIG. 26. In some examples, the translation is performed by hardware translation circuitry.

The one or more translated instructions of the second instruction set architecture are decoded at 943. For example, the translated instructions are decoded by decoder circuitry such as decoder circuitry 204 or decode circuitry 1740 detailed herein. In some examples, the operations of translation 942 and decoding 943 are merged.

Floating-point data elements associated with the source vector(s) of the decoded instruction may be retrieved when the decoded instruction is scheduled at 944. For example, when one or more of the source operands are memory operands, the data from the indicated memory location is retrieved.

At 945, the decoded instruction(s) of the second instruction set architecture is/are executed by execution circuitry (hardware) such as execution circuitry 206 shown in FIG. 2, or execution cluster(s) 1760 shown in FIG. 17 (B), to perform the operation(s) indicated by and/or according to the opcode of the single instruction of the first instruction set architecture. In some embodiments, these operations may include interpreting the floating-point data elements consistent with the at least one value (e.g., consistent with one or more of an indicated exponent bias, exponent bias offset, number of significand bits, number of exponent bits, etc.).

The operations may also include performing an operation specified by the instruction on the at least one source floating-point vector to generate a result floating-point vector. This may include handling the floating-point data elements consistent with the at least one value. Examples of suitable operations include, but are not limited to, vector addition, vector multiplication, vector fused multiplication and addition, vector floating-point format conversion, and other operations mentioned further below. These vector operations may either be masked/predicated or unmasked/unpredicated.

In some examples, the instruction is committed or retired at 946. This may cause the result vector to be stored in an architectural storage location used for the destination storage location.

Listed below is an example set of adjustable floating-point format instructions that optionally may be included in an instruction set. This set of adjustable floating-point format instructions provides a relatively wide range of processing capabilities. However, it is to be appreciated that the scope of the invention is not limited to including all of these instructions. In some embodiments only any subset (e.g., only any single one) of these instructions may optionally be included in an instruction set of a processor

VMULAFP zmm1 {k1} {z}, zmm2, zmm3/m512, imm8-Vector adjustable floating-point format multiplication instruction

VADDAFP zmm1 {k1} {z}, zmm2, zmm3/m512, imm8-Vector adjustable floating-point format addition instruction.

VFMAAFP zmm1 {k1} {z}, zmm2, zmm3/m512, imm8-Vector adjustable floating-point format fused multiply-add instruction.

VCVTAFP2AFP zmm1 {k1} {z}, zmm2, imm8-Vector convert from adjustable floating-point format to adjustable floating-point format instruction.

VCVTAFP2DP zmm1 {k1} {z}, zmm2, imm8-Vector convert from adjustable floating-point format to double precision instruction.

VCVTAFP2SP zmm1 {k1} {z}, zmm2, imm8-Vector convert from adjustable floating-point format to single precision instruction.

VCVTAFP2HP zmm1 {k1} {z}, zmm2, imm8-Vector convert from adjustable floating-point format to half precision instruction.

VCVTAFP2BF16 zmm1 {k1} {z}, zmm2, imm8-Vector convert from adjustable floating-point format to bfloa16 instruction.

VCVTAFP2E5M2 zmm1 {k1} {z}, zmm2, imm8-Vector convert from adjustable floating-point format to FP8 E5M2 instruction.

VCVTAFP2E4M3 zmm1 {k1} {z}, zmm2, imm8-Vector convert from adjustable floating-point format to FP8 E4M3 instruction.

VCVTDP2AFP zmm1 {k1} {z}, zmm2, imm8-Vector convert from double precision to adjustable floating-point format instruction.

VCVTSP2AFP zmm1 {k1} {z}, zmm2, imm8-Vector convert from single precision to adjustable floating-point format instruction.

VCVTHP2AFP zmm1 {k1} {z}, zmm2, imm8-Vector convert from half precision to adjustable floating-point format instruction.

VCVTBF162AFP zmm1 {k1} {z}, zmm2, imm8-Vector convert from bfloa16 precision to adjustable floating-point format instruction.

VCVTE5M22AFP zmm1 {k1} {z}, zmm2, imm8-Vector convert from FP8 E5M2 to adjustable floating-point format instruction.

VCVTE4M32AFP zmm1 {k1} {z}, zmm2, imm8-Vector convert from FP8 E4M3 to adjustable floating-point format instruction.

In the above instructions above, the zmm represent 512-bit packed or vector registers and the m512 represents a 512-bit memory operand used to store 512-bit vectors. Zmm1 is a destination register while zmm2 and zmm3 are source registers and m512 is for a source vector. In other embodiments one of the source registers may optionally be implicitly reused for the destination. In other embodiments the instructions may optionally instead use 128-bit, 256-bit, or 1024-bit vectors. The {k1} specifies a mask register as a source of a packed data operation mask or writemask. The {z} indicates the type of masking (e.g., merging-masking or zeroing masking). In other embodiments the instructions may optionally omit masking and therefore omit the {k1} and {z}. The imm8 represents an 8-bit immediate used to specify at least one value to adjust the floating-point format as described elsewhere herein. In other embodiments, the instructions may instead specify a 16-bit, 32-bit, or 64-bit general-purpose register as a source of the at least one value. In still other embodiments, the instructions may instead implicitly indicate that a floating point control register is to be used to store the at least one value. Other floating point behaviors such as rounding, flush to zero, and the like may also be controlled via controls in the floating point control register.

When the masking is omitted the instructions may perform unmasked vector operations. By way of example, for the first three listed instructions, this may include performing the respective multiplication, addition, or fused multiply add operation on each pair of corresponding (e.g., in the same relative bit positions) floating-point data elements of the first and second source floating-point vectors to generate the result floating-point vector having the results of the operations (e.g., the sums of the corresponding elements, products of the corresponding elements, or fused multiply addition results of the corresponding elements). The result floating point vector may be stored in the zmm1 register. The masked vector operations for the first three listed instructions may be similar but may only be performed on those corresponding pairs of floating-point data elements for which a corresponding mask bit or mask element is unmasked or a has a first value as opposed to being masked or having a second value. The masked out elements may have a masked value (e.g., a merged or zeroed value) depending on {2}. The source floating-point data elements may be interpreted according to the at least one value in the imm8, and any of the different types of values discussed above to adjust the floating point formats may be used.

When the masking is omitted, for the fourth through sixteenth listed instructions, the unmasked operation may include performing the respective floating point conversion operation on each floating-point data element of the source floating-point vector from zmm2 to generate the corresponding converted floating-point data elements of the result floating-point vector. The result floating point vector may be stored in the zmm1 register. The masked vector operations for the fourth through sixteenth listed instructions may be similar but the conversion operations may only be performed on those corresponding floating-point data elements of the source vector for which a corresponding mask bit or mask element is unmasked or a has a first value as opposed to being masked or having a second value. The masked out elements may have a masked value (e.g., a merged or zeroed value) depending on {2}. The source floating-point data elements may be interpreted according to the at least one value in the imm8, and any of the different types of values discussed above to adjust the floating point formats may be used.

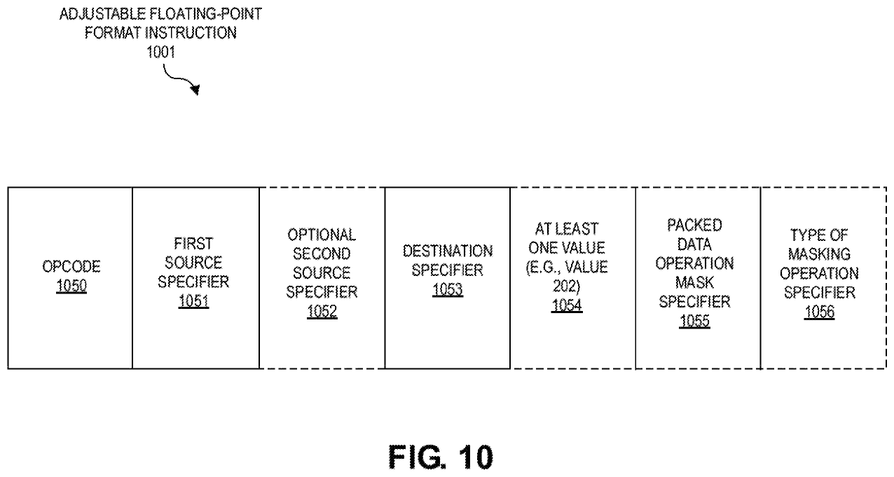

FIG. 10 is a block diagram of an example embodiment of an instruction format for an adjustable floating-point format instruction 1101. The instruction format includes an operation code or opcode 1050. The opcode may represent a plurality of bits or one or more fields that are operable to identify the instruction and/or the operation to be performed.

The instruction format includes a first source specifier 1051 to explicitly specify a register or memory address information for a first source floating-point vector, an optional second source floating-point vector specifier 1052 to explicitly specify a register or memory address information for a second source floating-point vector, and a destination specifier 1053 to explicitly specify a register or memory address information to be used as a destination where a result floating-point vector is to be stored. Alternatively, one or more of these may optionally be implicit (e.g., a source/destination register may be used). In some embodiments, the instruction format may also include one or more fields for at least one value 1054 (e.g., the at least one value 202) to provide adjustable floating-point format information.

In some embodiments in which the adjustable floating-point format instruction is a masked instruction, the instruction format may include an optional packed data operation mask specifier 1055 to explicitly specify a register (e.g., a mask register or vector register) or other storage location where a packed data operation mask is to be stored. Alternatively, the packed data operation mask may be implicitly indicated. In some embodiments, the instruction format may also include an optional type of masking operation specifier 1056 to specify a type of masking operation. By way of example, the type of masking operation specifier may include a single bit to specify whether merging-masking or zeroing-masking is to be performed. As mentioned above, masking is optional and not required.

The illustrated instruction format shows examples of the types of fields that may be included in an embodiment of an adjustable floating-point format instruction. Alternate embodiments may include a subset of the illustrated fields or may add additional fields. The illustrated order/arrangement of the fields is not required, but rather the fields may be rearranged. Fields need not include contiguous sequences of bits but rather may be composed of non-contiguous or separated bits. In some embodiments, the instruction format may use any of the other instruction formats or encoding schemes mentioned further below.

Circuitry to handle floating-point numbers of different and multiple precisions is known. To further illustrate certain concepts, a brief description will be provided. The description is for scalar processing, although these concepts may also be readily extended to vectors processing by replicating the approach per vector element.

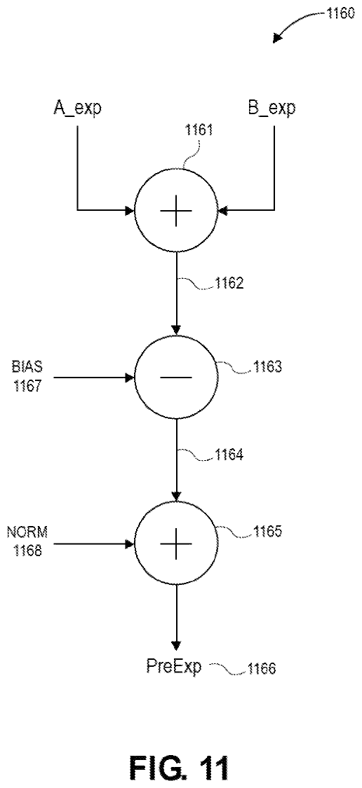

FIG. 11 shows circuitry 1160 for calculating exponents for multiplication of floating-point numbers with adjustable numbers of exponent bits (e.g., adjustable precision). The circuitry 1160 may include an input adder circuit 1161, a bias subtraction circuit 1163, and a normalization circuit 1165. The adder circuit 1161 may include a first input to receive a first exponent A_exp, a second input that receives a second exponent B_exp, and an output at which a sum 1162 of the two input exponents is provided. The adder circuit may have the precision of the largest possible exponent precision and lower values may be zero extended.

The sum 1162 may be subtracted by a bias value 1167 using bias subtraction circuit 1163. Consider a scenario in which the maximum exponent supported by the circuitry is 8 bits and the range of exponent bits is from 5 to 8 exponent bits. All additions and subtractions within circuitry for exponent widths less than 8 bits can be calculated by simply zeroing out the unused most significant bits (MSBs). For example, if the exponent precision is set to only 5 bits, the bias value may be set to “00001111.” As other examples, the bias value may be set to “00011111” for an exponent precision of 6 bits, to “00111111” for an exponent precision of 7 bits, and to “01111111” for an exponent precision of 8 bits. Note that only the upper four bits are being varied in this particular example, so the bottom four LSBs of the bias value “1111” may be hardwired to a logic one. This is just one example. Analogous circuitry may be used for other exponent/precision ranges.

A difference value 1164 at the output of the bias subtraction circuit 1163 may then be selectively incremented by a normalization value (norm) 1168 using adder circuit 1165. The single bit normalization value (if the post rounded mantissa is greater or equal to 2.0) is subtracted. Continuing with the 8 bit example above, the normalization value may have the form “0000000: norm” and be set to “00000000” for a non-bridged mode and may be set to “00000001” for a bridged mode (i.e., when right-shifting the rounding position of the mantissa by one bit). In other words, only the least significant bit (LSB) of the normalization value 1168 toggles between the two modes while all leading bits are zeroes. Since only the LSB changes, the normalization adjustment implementation may be the same for all exponent sizes. Operated as such, output adder circuit generates a corresponding pre-exponent output (PreExp) 1166.

Exceptions may also be handled for both the mantissas and the exponents. This includes checking the inputs and outputs for underflow, overflow (infinity), and special numbers such as not-a-number (NaN) (e.g., a number divided by zero).

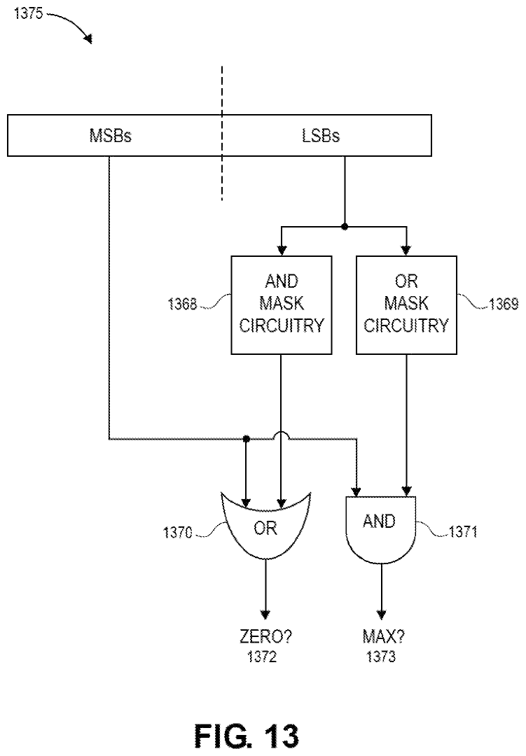

FIG. 13 is a diagram of illustrative exponent exception and error range masking circuitry 1375 that can be used to detect exceptions for floating-point numbers with adjustable numbers of exponent bits. The circuitry includes logic AND mask circuitry 1368, logic OR mask circuitry 1369, logic OR gate 1370, and logic AND gate 1371.

The circuitry is coupled to receive most significant bits (MSBs) and least significant bits (LSBs) of an exponent field. The upper bits of the exponent field are the same in all cases may be used directly and may be unmasked. A mask is applied to the lower bits, depending on the adjustable number of exponent bits. Note that the upper bits or lower bits correspond to the position of the exponent bits in the floating-point format.

In an example where the number of exponent bits ranges from 5 to 8, the lower 4 bits (LSBs) may be logically ANDed with an AND mask value with a ‘1’ in positions where the exponent may have a valid bit by logical AND mask circuitry 1368. All the bits, masked and unmasked may be ORed together by logical OR gate 1370 to check for a non-zero value. If an output (zero?) 1372 of logical OR gate 1370 is zero, a zero exponent has been detected.

The lower 4 bits may be ORed with an OR mask value with ‘1’ in positions where there is no exponent (this will be mantissa instead) by logical OR mask circuitry 1369. All of these values may be logically ANDed with logical AND gate 1371 with the actual exponent bits to look for a maximum number. If an output (max?) 1373 of logical AND gate 1371 is high (e.g., all exponent bits are ‘1’), then an overflow (e.g., infinity) has been detected. This may be handled multiple ways. This may be either output as an infinity or NaN, depending on the format defined for these non-IEEE754 numbers, or may be handled as defined by the IEEE754 standard, for example if the precisions are configured like FP16.

The tables below illustrate the AND mask values for the logical AND mask 1268 and the OR mask values for the logical OR mask 1269 for the upper bits for exponent bits ranging from 5-8 bits (as examples):

| Exponent | AND Mask |
|---|---|
| Bits | Value |
| 5 | 1000 |
| 6 | 1100 |
| 7 | 1110 |
| 8 | 1111 |

| Exponent | OR Mask |
|---|---|
| Bits | Value |
| 5 | 0111 |
| 6 | 0011 |
| 7 | 0001 |
| 8 | 0000 |

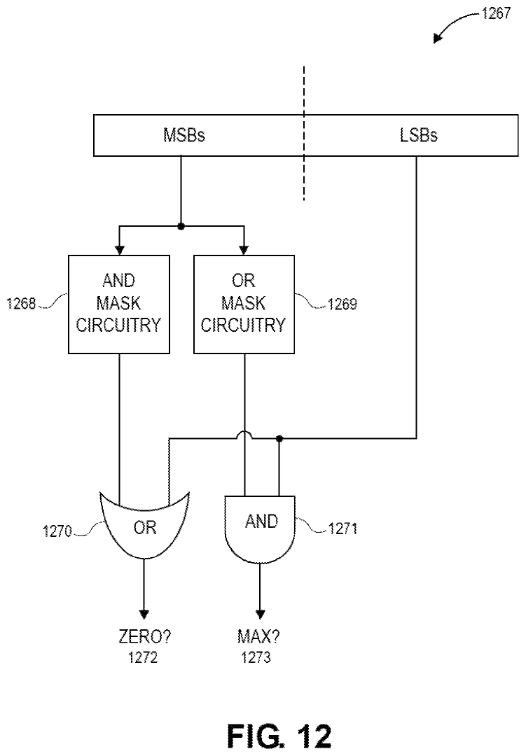

Mantissa exception and error range masking may be handled in an analogous way, except the upper bits may be masked, because this is where the exponent bits are as the exponent increases in size (and the mantissa decreases in size by the same amount). FIG. 12 is a diagram of illustrative mantissa exception and error range masking circuitry 1267 that can be used to detect exceptions for floating-point numbers with adjustable numbers of exponent bits. The circuitry includes logic AND mask circuitry 1268, logic OR mask circuitry 1269, logic OR gate 1270, and logic AND gate 1271. The circuitry is coupled to receive most significant bits (MSBs) and least significant bits (LSBs).

Although the example here is that the mantissa is checked for a maximum (i.e. “11 . . . 11”), this is only an example. The mantissa may be checked for a different value, or just that it is non-zero. If it is checked for non-zero, this can simply be the inverse of the zero signal. A maximum exponent and a zero mantissa may mean that an infinity is coded. A maximum exponent and a maximum mantissa may signify a not-a-number (NaN). Alternately, a maximum exponent and some other non-zero mantissa may signal a particular error condition.

The tables below illustrate the AND mask values for the logical AND mask 1368 and the OR mask values for the logical OR mask 1369 for mantissa bits ranging from 7-10 bits (as examples):

| Mantissa | AND Mask |
|---|---|
| Bits | Value |
| 10 | 0000 |
| 9 | 0001 |
| 8 | 0011 |
| 7 | 0111 |

| Mantissa | OR Mask |
|---|---|
| Bits | Value |
| 10 | 1110 |
| 9 | 1100 |
| 8 | 1000 |
| 7 | 0000 |

Optionally, the largest precision possible mantissa multiplier may be built to support all the possible mantissa sizes for the supported adjustable precision floating-point numbers. For example, the processors may naturally be built with various splits of integer multipliers and in one embodiment the circuitry may match dynamically to the next bigger integer multiplier available according to the adjustable floating-point format indicated by the instruction. A smaller mantissa multiplier may occupy a sub region of a larger multiplier (e.g., an array multiplier or other type of multiplier architecture).

In floating point, mantissa multiplications for a M-bit mantissa are a (M+1)*(M+1) unsinged multiplication as the implied leading ‘1’ needs to be added. The output is therefore 2M+2 bits. The mantissa is generally rounded, and this rounding may also be calculated. The rounding position is after M+1 bits from the right. Rounding decisions may be based on the type of rounding, for example round nearest even (RNE), the round bit position (e.g., the (M+1)th bit from the right), the guard bit (e.g., the Mth bit from the right), and the sticky bit (e.g., the logical OR of all bits (M to 1) from the right). The LSB of the mantissa region (e.g., the (M+2)th bit from the right) may also be used.

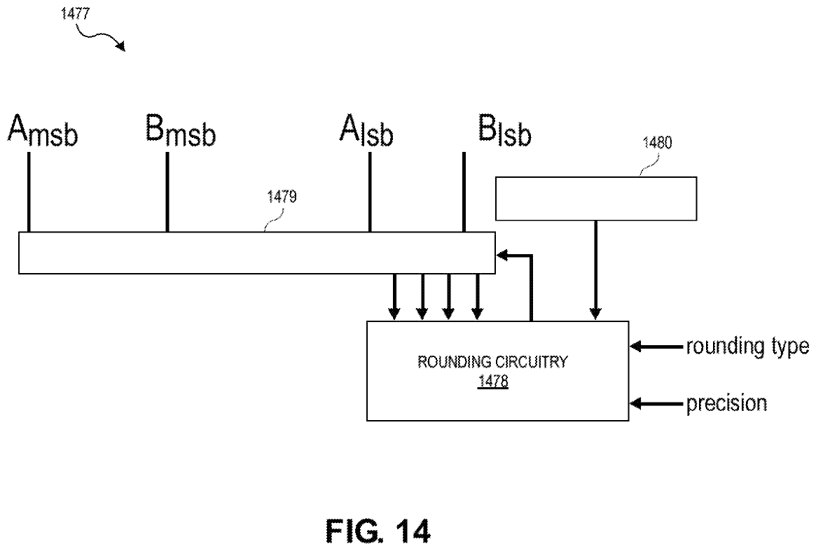

FIG. 14 shows circuitry 1477 to perform adjustable precision mantissa rounding. The circuitry includes a most significant bit portion 1479, and a least significant bit portion 1480 of a significand multiplier output. The portions are split based on the range of significand bits. The most significant bit portion includes bits A_{msb}, A_{lsb}, B_{msb}, and B_{lsb}. The circuitry also includes rounding circuitry 1478. The rounding circuitry receives an input precision and rounding type or mode. The rounding circuitry will determine a rounding position based on the adjustable size of the significand bits and the corresponding significand multiplier output. A universal sticky bit is calculated for the smallest mantissa. The rounding value is then a function of the LSB of the selected mantissa, the round position of the selected mantissa, the guard position of the selected mantissa, and the logical OR of all bits between the smallest mantissa sticky region and the selected mantissa guard position. Multiple possible round bits may be calculated, and the correct one selected based on the adjustable size of the significand and the rounding mode. Both +1 and +2 round values may be calculated, and applied. By way of example, this may be done using a structure known as a flagged prefix adder. The rounding circuitry may include circuitry (e.g., combinatorial circuitry) to take the input bits and based on the rounding mode and the round position decide which bits are used to perform the rounding.

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

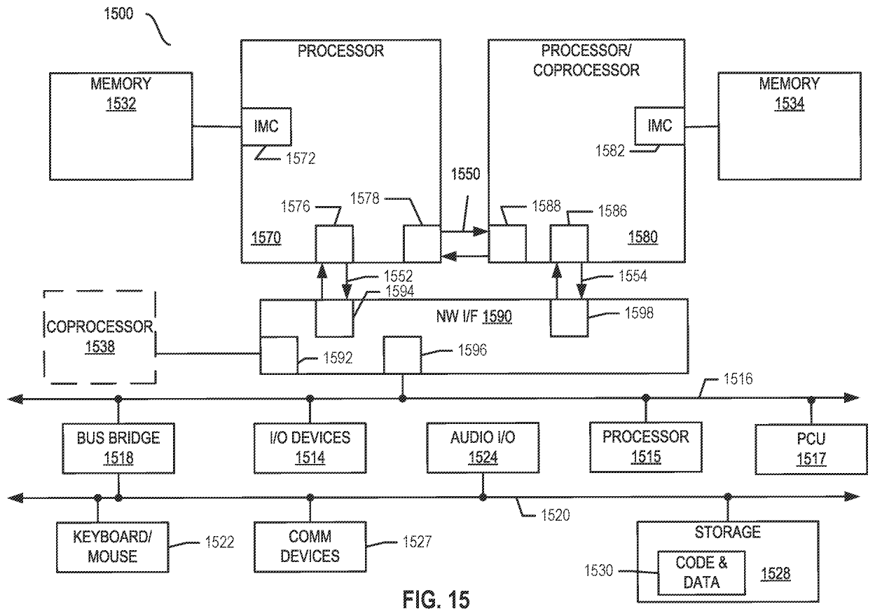

FIG. 15 illustrates an example computing system. Multiprocessor system 1500 is an interfaced system and includes a plurality of processors or cores including a first processor 1570 and a second processor 1580 coupled via an interface 1550 such as a point-to-point (P-P) interconnect, a fabric, and/or bus. In some examples, the first processor 1570 and the second processor 1580 are homogeneous. In some examples, first processor 1570 and the second processor 1580 are heterogenous. Though the example system 1500 is shown to have two processors, the system may have three or more processors, or may be a single processor system. In some examples, the computing system is a system on a chip (SoC).

Processors 1570 and 1580 are shown including integrated memory controller (IMC) circuitry 1572 and 1582, respectively. Processor 1570 also includes interface circuits 1576 and 1578; similarly, second processor 1580 includes interface circuits 1586 and 1588. Processors 1570, 1580 may exchange information via the interface 1550 using interface circuits 1578, 1588. IMCs 1572 and 1582 couple the processors 1570, 1580 to respective memories, namely a memory 1532 and a memory 1534, which may be portions of main memory locally attached to the respective processors.

Processors 1570, 1580 may each exchange information with a network interface (NW I/F) 1590 via individual interfaces 1552, 1554 using interface circuits 1576, 1594, 1586, 1598. The network interface 1590 (e.g., one or more of an interconnect, bus, and/or fabric, and in some examples is a chipset) may optionally exchange information with a coprocessor 1538 via an interface circuit 1592. In some examples, the coprocessor 1538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1570, 1580 or outside of both processors, yet connected with the processors via an interface such as P-P interconnect, such that either or both processors' local cache information may be stored in the shared cache if a processor is placed into a low power mode.

Network interface 1590 may be coupled to a first interface 1516 via interface circuit 1596. In some examples, first interface 1516 may be an interface such as a Peripheral Component Interconnect (PCI) interconnect, a PCI Express interconnect or another I/O interconnect. In some examples, first interface 1516 is coupled to a power control unit (PCU) 1517, which may include circuitry, software, and/or firmware to perform power management operations with regard to the processors 1570, 1580 and/or co-processor 1538. PCU 1517 provides control information to a voltage regulator (not shown) to cause the voltage regulator to generate the appropriate regulated voltage. PCU 1517 also provides control information to control the operating voltage generated. In various examples, PCU 1517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1517 is illustrated as being present as logic separate from the processor 1570 and/or processor 1580. In other cases, PCU 1517 may execute on a given one or more of cores (not shown) of processor 1570 or 1580. In some cases, PCU 1517 may be implemented as a microcontroller (dedicated or general-purpose) or other control logic configured to execute its own dedicated power management code, sometimes referred to as P-code. In yet other examples, power management operations to be performed by PCU 1517 may be implemented externally to a processor, such as by way of a separate power management integrated circuit (PMIC) or another component external to the processor. In yet other examples, power management operations to be performed by PCU 1517 may be implemented within BIOS or other system software.

Various I/O devices 1514 may be coupled to first interface 1516, along with a bus bridge 1518 which couples first interface 1516 to a second interface 1520. In some examples, one or more additional processor(s) 1515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1516. In some examples, second interface 1520 may be a low pin count (LPC) interface. Various devices may be coupled to second interface 1520 including, for example, a keyboard and/or mouse 1522, communication devices 1527 and storage circuitry 1528. Storage circuitry 1528 may be one or more non-transitory machine-readable storage media as described below, such as a disk drive or other mass storage device which may include instructions/code and data 1530 and may implement the storage 'ISAB03 in some examples. Further, an audio I/O 1524 may be coupled to second interface 1520. Note that other architectures than the point-to-point architecture described above are possible. For example, instead of the point-to-point architecture, a system such as multiprocessor system 1500 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

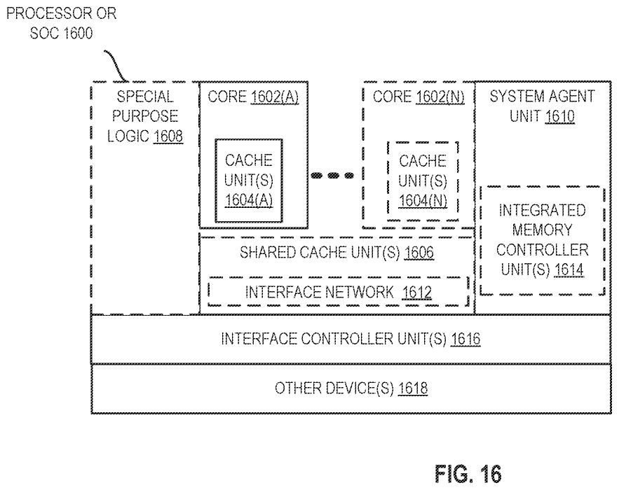

FIG. 16 illustrates a block diagram of an example processor and/or SoC 1600 that may have one or more cores and an integrated memory controller. The solid lined boxes illustrate a processor 1600 with a single core 1602 (A), system agent unit circuitry 1610, and a set of one or more interface controller unit(s) circuitry 1616, while the optional addition of the dashed lined boxes illustrates an alternative processor 1600 with multiple cores 1602 (A)-(N), a set of one or more integrated memory controller unit(s) circuitry 1614 in the system agent unit circuitry 1610, and special purpose logic 1608, as well as a set of one or more interface controller units circuitry 1616. Note that the processor 1600 may be one of the processors 1570 or 1580, or co-processor 1538 or 1515 of FIG. 15.

Thus, different implementations of the processor 1600 may include: 1) a CPU with the special purpose logic 1608 being integrated graphics and/or scientific (throughput) logic (which may include one or more cores, not shown), and the cores 1602 (A)-(N) being one or more general purpose cores (e.g., general purpose in-order cores, general purpose out-of-order cores, or a combination of the two); 2) a coprocessor with the cores 1602 (A)-(N) being a large number of special purpose cores intended primarily for graphics and/or scientific (throughput); and 3) a coprocessor with the cores 1602 (A)-(N) being a large number of general purpose in-order cores. Thus, the processor 1600 may be a general-purpose processor, coprocessor, or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1604 (A)-(N) within the cores 1602 (A)-(N), a set of one or more shared cache unit(s) circuitry 1606, and external memory (not shown) coupled to the set of integrated memory controller unit(s) circuitry 1614. The set of one or more shared cache unit(s) circuitry 1606 may include one or more mid-level caches, such as level 2 (L2), level 3 (L3), level 4 (L4), or other levels of cache, such as a last level cache (LLC), and/or combinations thereof. While in some examples interface network circuitry 1612 (e.g., a ring interconnect) interfaces the special purpose logic 1608 (e.g., integrated graphics logic), the set of shared cache unit(s) circuitry 1606, and the system agent unit circuitry 1610, alternative examples use any number of well-known techniques for interfacing such units. In some examples, coherency is maintained between one or more of the shared cache unit(s) circuitry 1606 and cores 1602 (A)-(N). In some examples, interface controller units circuitry 1616 couple the cores 1602 to one or more other devices 1618 such as one or more I/O devices, storage, one or more communication devices (e.g., wireless networking, wired networking, etc.), etc.

In some examples, one or more of the cores 1602 (A)-(N) are capable of multi-threading. The system agent unit circuitry 1610 includes those components coordinating and operating cores 1602 (A)-(N). The system agent unit circuitry 1610 may include, for example, power control unit (PCU) circuitry and/or display unit circuitry (not shown). The PCU may be or may include logic and components needed for regulating the power state of the cores 1602 (A)-(N) and/or the special purpose logic 1608 (e.g., integrated graphics logic). The display unit circuitry is for driving one or more externally connected displays.

The cores 1602 (A)-(N) may be homogenous in terms of instruction set architecture (ISA). Alternatively, the cores 1602 (A)-(N) may be heterogeneous in terms of ISA; that is, a subset of the cores 1602 (A)-(N) may be capable of executing an ISA, while other cores may be capable of executing only a subset of that ISA or another ISA.

### Example Core Architectures—In-Order and Out-of-Order Core Block Diagram.

FIG. 17 (A) is a block diagram illustrating both an example in-order pipeline and an example register renaming, out-of-order issue/execution pipeline according to examples. FIG. 17 (B) is a block diagram illustrating both an example in-order architecture core and an example register renaming, out-of-order issue/execution architecture core to be included in a processor according to examples. The solid lined boxes in FIGS. 17 (A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 17 (A), a processor pipeline 1700 includes a fetch stage 1702, an optional length decoding stage 1704, a decode stage 1706, an optional allocation (Alloc) stage 1708, an optional renaming stage 1710, a schedule (also known as a dispatch or issue) stage 1712, an optional register read/memory read stage 1714, an execute stage 1716, a write back/memory write stage 1718, an optional exception handling stage 1722, and an optional commit stage 1724. One or more operations can be performed in each of these processor pipeline stages. For example, during the fetch stage 1702, one or more instructions are fetched from instruction memory, and during the decode stage 1706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1706 and the register read/memory read stage 1714 may be combined into one pipeline stage. In one example, during the execute stage 1716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 17 (B) may implement the pipeline 1700 as follows: 1) the instruction fetch circuitry 1738 performs the fetch and length decoding stages 1702 and 1704; 2) the decode circuitry 1740 performs the decode stage 1706; 3) the rename/allocator unit circuitry 1752 performs the allocation stage 1708 and renaming stage 1710; 4) the scheduler(s) circuitry 1756 performs the schedule stage 1712; 5) the physical register file(s) circuitry 1758 and the memory unit circuitry 1770 perform the register read/memory read stage 1714; the execution cluster(s) 1760 perform the execute stage 1716; 6) the memory unit circuitry 1770 and the physical register file(s) circuitry 1758 perform the write back/memory write stage 1718; 7) various circuitry may be involved in the exception handling stage 1722; and 8) the retirement unit circuitry 1754 and the physical register file(s) circuitry 1758 perform the commit stage 1724.

FIG. 17 (B) shows a processor core 1790 including front-end unit circuitry 1730 coupled to execution engine unit circuitry 1750, and both are coupled to memory unit circuitry 1770. The core 1790 may be a reduced instruction set architecture computing (RISC) core, a complex instruction set architecture computing (CISC) core, a very long instruction word (VLIW) core, or a hybrid or alternative core type. As yet another option, the core 1790 may be a special-purpose core, such as, for example, a network or communication core, compression engine, coprocessor core, general purpose computing graphics processing unit (GPGPU) core, graphics core, or the like.

The front-end unit circuitry 1730 may include branch prediction circuitry 1732 coupled to instruction cache circuitry 1734, which is coupled to an instruction translation lookaside buffer (TLB) 1736, which is coupled to instruction fetch circuitry 1738, which is coupled to decode circuitry 1740. In one example, the instruction cache circuitry 1734 is included in the memory unit circuitry 1770 rather than the front-end circuitry 1730. The decode circuitry 1740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1740 may further include address generation unit (AGU, not shown) circuitry. In one example, the AGU generates an LSU address using forwarded register ports, and may further perform branch forwarding (e.g., immediate offset branch forwarding. LR register branch forwarding, etc.). The decode circuitry 1740 may be implemented using various different mechanisms. Examples of suitable mechanisms include, but are not limited to, look-up tables, hardware implementations, programmable logic arrays (PLAs), microcode read only memories (ROMs), etc. In one example, the core 1790 includes a microcode ROM (not shown) or other medium that stores microcode for certain macroinstructions (e.g., in decode circuitry 1740 or otherwise within the front-end circuitry 1730). In one example, the decode circuitry 1740 includes a micro-operation (micro-op) or operation cache (not shown) to hold/cache decoded operations, micro-tags, or micro-operations generated during the decode or other stages of the processor pipeline 1700. The decode circuitry 1740 may be coupled to rename/allocator unit circuitry 1752 in the execution engine circuitry 1750.

The execution engine circuitry 1750 includes the rename/allocator unit circuitry 1752 coupled to retirement unit circuitry 1754 and a set of one or more scheduler(s) circuitry 1756. The scheduler(s) circuitry 1756 represents any number of different schedulers, including reservations stations, central instruction window, etc. In some examples, the scheduler(s) circuitry 1756 can include arithmetic logic unit (ALU) scheduler/scheduling circuitry, ALU queues, address generation unit (AGU) scheduler/scheduling circuitry, AGU queues, etc. The scheduler(s) circuitry 1756 is coupled to the physical register file(s) circuitry 1758. Each of the physical register file(s) circuitry 1758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1758 includes vector registers unit circuitry, writemask registers unit circuitry, and scalar register unit circuitry. These register units may provide architectural vector registers, vector mask registers, general-purpose registers, etc. The physical register file(s) circuitry 1758 is coupled to the retirement unit circuitry 1754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1754 and the physical register file(s) circuitry 1758 are coupled to the execution cluster(s) 1760. The execution cluster(s) 1760 includes a set of one or more execution unit(s) circuitry 1762 and a set of one or more memory access circuitry 1764. The execution unit(s) circuitry 1762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1756, physical register file(s) circuitry 1758, and execution cluster(s) 1760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1764). It should also be understood that where separate pipelines are used, one or more of these pipelines may be out-of-order issue/execution and the rest in-order.

In some examples, the execution engine unit circuitry 1750 may perform load store unit (LSU) address/data pipelining to an Advanced Microcontroller Bus (AMB) interface (not shown), and address phase and writeback, data phase load, store, and branches.

The set of memory access circuitry 1764 is coupled to the memory unit circuitry 1770, which includes data TLB circuitry 1772 coupled to data cache circuitry 1774 coupled to level 2 (L2) cache circuitry 1776. In one example, the memory access circuitry 1764 may include load unit circuitry, store address unit circuitry, and store data unit circuitry, each of which is coupled to the data TLB circuitry 1772 in the memory unit circuitry 1770. The instruction cache circuitry 1734 is further coupled to the level 2 (L2) cache circuitry 1776 in the memory unit circuitry 1770. In one example, the instruction cache 1734 and the data cache 1774 are combined into a single instruction and data cache (not shown) in L2 cache circuitry 1776, level 3 (L3) cache circuitry (not shown), and/or main memory. The L2 cache circuitry 1776 is coupled to one or more other levels of cache and eventually to a main memory.

The core 1790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1790 includes logic to support a packed data instruction set architecture extension (e.g., AVX1, AVX2), thereby allowing the operations used by many multimedia applications to be performed using packed data.

### Example Execution Unit(s) Circuitry.

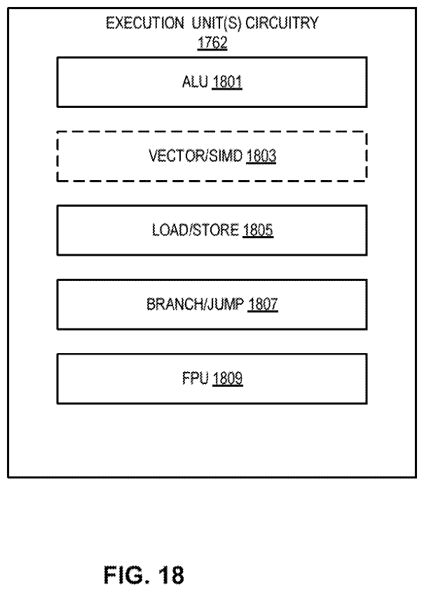

FIG. 18 illustrates examples of execution unit(s) circuitry, such as execution unit(s) circuitry 1762 of FIG. 17 (B). As illustrated, execution unit(s) circuitry 1762 may include one or more ALU circuits 1801, optional vector/single instruction multiple data (SIMD) circuits 1803, load/store circuits 1805, branch/jump circuits 1807, and/or Floating-point unit (FPU) circuits 1809. ALU circuits 1801 perform integer arithmetic and/or Boolean operations. Vector/SIMD circuits 1803 perform vector/SIMD operations on packed data (such as SIMD/vector registers). Load/store circuits 1805 execute load and store instructions to load data from memory into registers or store from registers to memory. Load/store circuits 1805 may also generate addresses. Branch/jump circuits 1807 cause a branch or jump to a memory address depending on the instruction. FPU circuits 1809 perform floating-point arithmetic. The width of the execution unit(s) circuitry 1762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

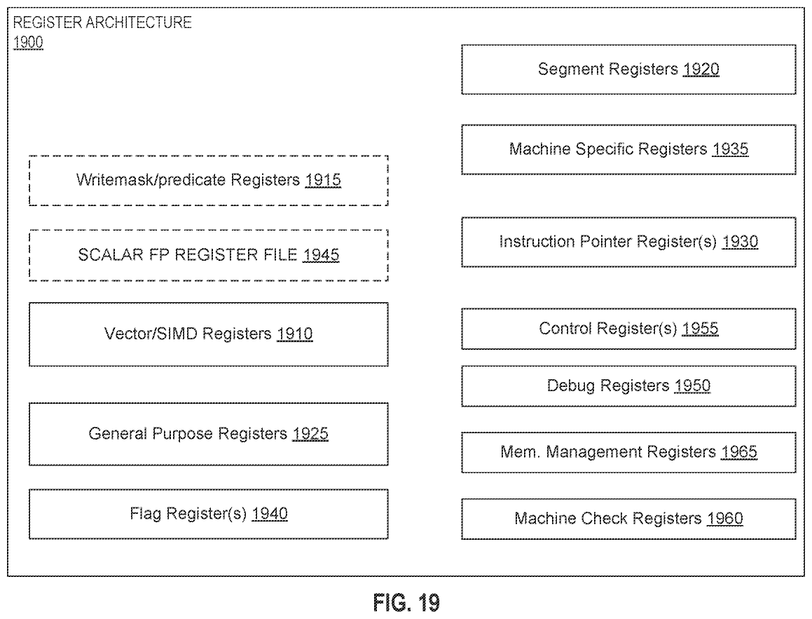

FIG. 19 is a block diagram of a register architecture 1900 according to some examples. As illustrated, the register architecture 1900 includes vector/SIMD registers 1910 that vary from 128-bit to 1,024 bits width. In some examples, the vector/SIMD registers 1910 are physically 512-bits and, depending upon the mapping, only some of the lower bits are used. For example, in some examples, the vector/SIMD registers 1910 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1900 includes writemask/predicate registers 1915. For example, in some examples, there are 8 writemask/predicate registers (sometimes called k0 through k7) that are each 16-bit, 32-bit, 64-bit, or 128-bit in size. Writemask/predicate registers 1915 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1915 corresponds to a data element position of the destination. In other examples, the writemask/predicate registers 1915 are scalable and consists of a set number of enable bits for a given vector element (e.g., 8 enable bits per 64-bit vector element).

The register architecture 1900 includes a plurality of general-purpose registers 1925. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1900 includes scalar floating-point (FP) register file 1945 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1940 (e.g., EFLAGS, RFLAGS, etc.) store status and control information for arithmetic, compare, and system operations. For example, the one or more flag registers 1940 may store condition code information such as carry, parity, auxiliary carry, zero, sign, and overflow. In some examples, the one or more flag registers 1940 are called program status and control registers.

Segment registers 1920 contain segment points for use in accessing memory. In some examples, these registers are referenced by the names CS, DS, SS, ES, FS, and GS.

Machine specific registers (MSRs) 1935 control and report on processor performance. Most MSRs 1935 handle system-related functions and are not accessible to an application program. Machine check registers 1960 consist of control, status, and error reporting MSRs that are used to detect and report on hardware errors.

One or more instruction pointer register(s) 1930 store an instruction pointer value. Control register(s) 1955 (e.g., CR0-CR4) determine the operating mode of a processor (e.g., processor 1570, 1580, 1538, 1515, and/or 1600) and the characteristics of a currently executing task. Debug registers 1950 control and allow for the monitoring of a processor or core's debugging operations.

Memory (mem) management registers 1965 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1900 may, for example, be used in register file/memory 'ISAB08, or physical register file(s) circuitry 1758.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 20 illustrates examples of an instruction format. As illustrated, an instruction may include multiple components including, but not limited to, one or more fields for: one or more prefixes 2001, an opcode 2003, addressing information 2005 (e.g., register identifiers, memory addressing information, etc.), a displacement value 2007, and/or an immediate value 2009. Note that some instructions utilize some or all the fields of the format whereas others may only use the field for the opcode 2003. In some examples, the order illustrated is the order in which these fields are to be encoded, however, it should be appreciated that in other examples these fields may be encoded in a different order, combined, etc.

The prefix(es) field(s) 2001, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 2003 is used to at least partially define the operation to be performed upon a decoding of the instruction. In some examples, a primary opcode encoded in the opcode field 2003 is one, two, or three bytes in length. In other examples, a primary opcode can be a different length. An additional 3-bit opcode field is sometimes encoded in another field.

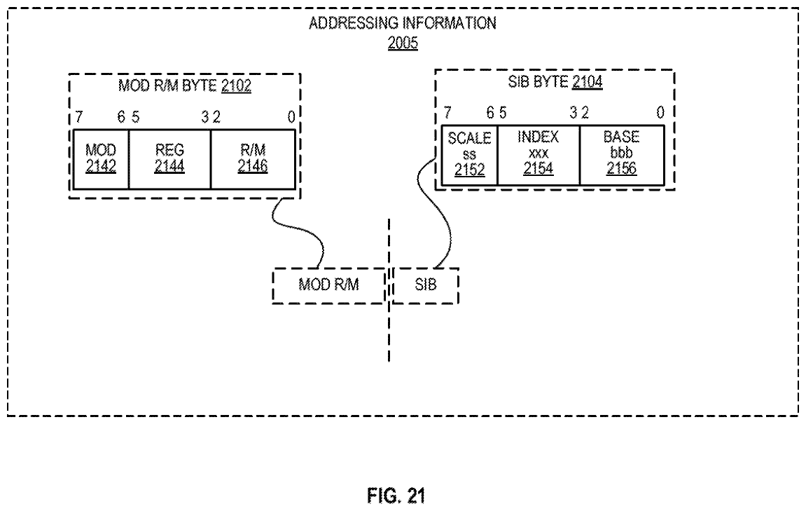

The addressing information field 2005 is used to address one or more operands of the instruction, such as a location in memory or one or more registers. FIG. 21 illustrates examples of the addressing information field 2005. In this illustration, an optional MOD R/M byte 2102 and an optional Scale, Index, Base (SIB) byte 2104 are shown. The MOD R/M byte 2102 and the SIB byte 2104 are used to encode up to two operands of an instruction, each of which is a direct register or effective memory address. Note that both of these fields are optional in that not all instructions include one or more of these fields. The MOD R/M byte 2102 includes a MOD field 2142, a register (reg) field 2144, and R/M field 2146.

The content of the MOD field 2142 distinguishes between memory access and non-memory access modes. In some examples, when the MOD field 2142 has a binary value of 11 (11b), a register-direct addressing mode is utilized, and otherwise a register-indirect addressing mode is used.

The register field 2144 may encode either the destination register operand or a source register operand or may encode an opcode extension and not be used to encode any instruction operand. The content of register field 2144, directly or through address generation, specifies the locations of a source or destination operand (either in a register or in memory). In some examples, the register field 2144 is supplemented with an additional bit from a prefix (e.g., prefix 2001) to allow for greater addressing.

The R/M field 2146 may be used to encode an instruction operand that references a memory address or may be used to encode either the destination register operand or a source register operand. Note the R/M field 2146 may be combined with the MOD field 2142 to dictate an addressing mode in some examples.

The SIB byte 2104 includes a scale field 2152, an index field 2154, and a base field 2156 to be used in the generation of an address. The scale field 2152 indicates a scaling factor. The index field 2154 specifies an index register to use. In some examples, the index field 2154 is supplemented with an additional bit from a prefix (e.g., prefix 2001) to allow for greater addressing. The base field 2156 specifies a base register to use. In some examples, the base field 2156 is supplemented with an additional bit from a prefix (e.g., prefix 2001) to allow for greater addressing. In practice, the content of the scale field 2152 allows for the scaling of the content of the index field 2154 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 2007 provides this value. Additionally, in some examples, a displacement factor usage is encoded in the MOD field of the addressing information field 2005 that indicates a compressed displacement scheme for which a displacement value is calculated and stored in the displacement field 2007.

In some examples, the immediate value field 2009 specifies an immediate value for the instruction. An immediate value may be encoded as a 1-byte value, a 2-byte value, a 4-byte value, etc.

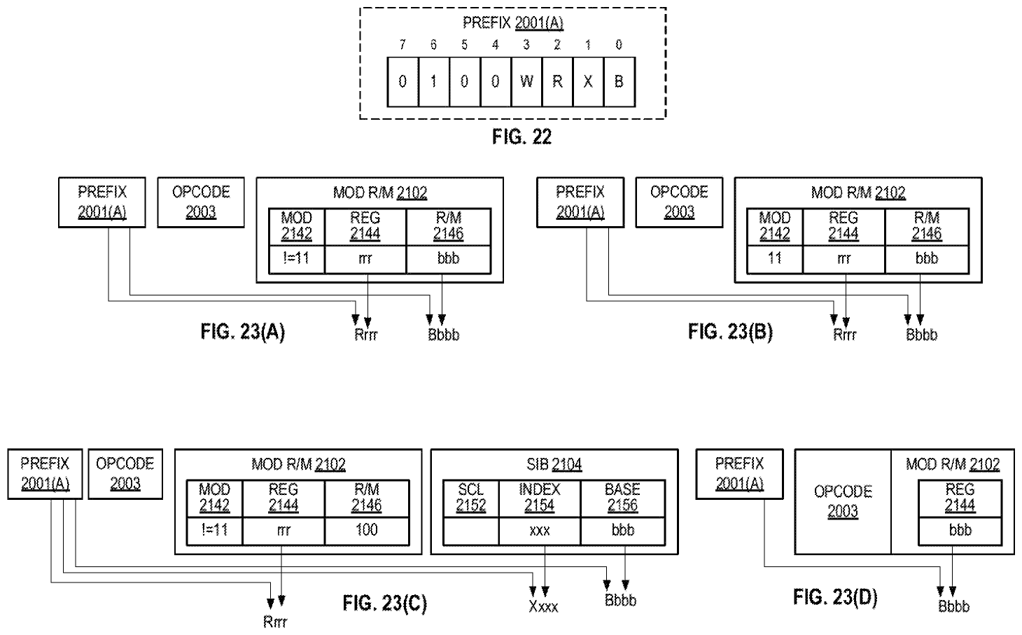

FIG. 22 illustrates examples of a first prefix 2001 (A). In some examples, the first prefix 2001 (A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 2001 (A) may specify up to three registers using 3-bit fields depending on the format: 1) using the reg field 2144 and the R/M field 2146 of the MOD R/M byte 2102; 2) using the MOD R/M byte 2102 with the SIB byte 2104 including using the reg field 2144 and the base field 2156 and index field 2154; or 3) using the register field of an opcode.

In the first prefix 2001 (A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 2144 and MOD R/M R/M field 2146 alone can each only address 8 registers.

In the first prefix 2001 (A), bit position 2 (R) may be an extension of the MOD R/M reg field 2144 and may be used to modify the MOD R/M reg field 2144 when that field encodes a general-purpose register, a 64-bit packed data register (e.g., a SSE register), or a control or debug register. R is ignored when MOD R/M byte 2102 specifies other registers or defines an extended opcode.

Bit position 1 (X) may modify the SIB byte index field 2154.

Bit position 0 (B) may modify the base in the MOD R/M R/M field 2146 or the SIB byte base field 2156; or it may modify the opcode register field used for accessing general purpose registers (e.g., general purpose registers 1925).

FIGS. 23 (A)-(D) illustrate examples of how the R. X, and B fields of the first prefix 2001 (A) are used. FIG. 23 (A) illustrates R and B from the first prefix 2001 (A) being used to extend the reg field 2144 and R/M field 2146 of the MOD R/M byte 2102 when the SIB byte 21 04 is not used for memory addressing. FIG. 23 (B) illustrates R and B from the first prefix 2001 (A) being used to extend the reg field 2144 and R/M field 2146 of the MOD R/M byte 2102 when the SIB byte 21 04 is not used (register-register addressing). FIG. 23 (C) illustrates R, X, and B from the first prefix 2001 (A) being used to extend the reg field 2144 of the MOD R/M byte 2102 and the index field 2154 and base field 2156 when the SIB byte 21 04 being used for memory addressing. FIG. 23 (D) illustrates B from the first prefix 2001 (A) being used to extend the reg field 2144 of the MOD R/M byte 2102 when a register is encoded in the opcode 2003.

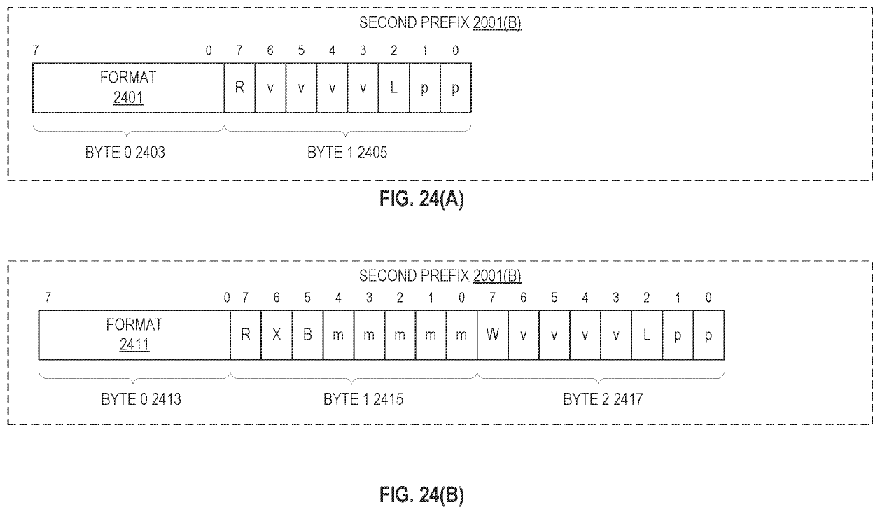

FIGS. 24 (A)-(B) illustrate examples of a second prefix 2001 (B). In some examples, the second prefix 2001 (B) is an example of a VEX prefix. The second prefix 2001 (B) encoding allows instructions to have more than two operands, and allows SIMD vector registers (e.g., vector/SIMD registers 1910) to be longer than 64-bits (e.g., 128-bit and 256-bit). The use of the second prefix 2001 (B) provides for three-operand (or more) syntax. For example, previous two-operand instructions performed operations such as A=A+B, which overwrites a source operand. The use of the second prefix 2001 (B) enables operands to perform nondestructive operations such as A=B+C.

In some examples, the second prefix 2001 (B) comes in two forms—a two-byte form and a three-byte form. The two-byte second prefix 2001 (B) is used mainly for 128-bit, scalar, and some 256-bit instructions; while the three-byte second prefix 2001 (B) provides a compact replacement of the first prefix 2001 (A) and 3-byte opcode instructions.

FIG. 24 (A) illustrates examples of a two-byte form of the second prefix 2001 (B). In one example, a format field 2401 (byte 0 2403) contains the value C5H. In one example, byte 1 2405 includes an “R” value in bit [7]. This value is the complement of the “R” value of the first prefix 2001 (A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 2146 to encode the instruction operand that references a memory address or encode either the destination register operand or a source register operand.

Instructions that use this prefix may use the MOD R/M reg field 2144 to encode either the destination register operand or a source register operand, or to be treated as an opcode extension and not used to encode any instruction operand.

For instruction syntax that support four operands, vvvv, the MOD R/M R/M field 2146 and the MOD R/M reg field 2144 encode three of the four operands. Bits [7:4] of the immediate value field 2009 are then used to encode the third source register operand.

FIG. 24 (B) illustrates examples of a three-byte form of the second prefix 2001 (B). In one example, a format field 2411 (byte 0 2413) contains the value C4H. Byte 1 2415 includes in bits [7:5] “R,” “X,” and “B” which are the complements of the same values of the first prefix 2001 (A). Bits [4:0] of byte 1 2415 (shown as mmmmm) include content to encode, as need, one or more implied leading opcode bytes. For example, 00001 implies a OFH leading opcode, 00010 implies a OF38H leading opcode, 00011 implies a OF3AH leading opcode, etc.

Bit [7] of byte 2 2417 is used similar to W of the first prefix 2001 (A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10-F3H, and 11=F2H). Bits [6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 2146 to encode the instruction operand that references a memory address or encode either the destination register operand or a source register operand.

Instructions that use this prefix may use the MOD R/M reg field 2144 to encode either the destination register operand or a source register operand, or to be treated as an opcode extension and not used to encode any instruction operand.

For instruction syntax that support four operands, vvvv, the MOD R/M R/M field 2146, and the MOD R/M reg field 2144 encode three of the four operands. Bits [7:4] of the immediate value field 2009 are then used to encode the third source register operand.

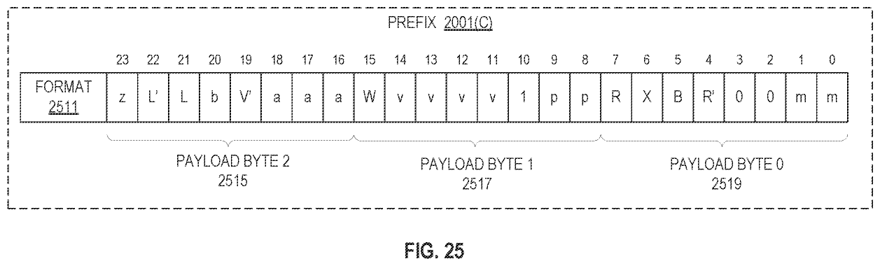

FIG. 25 illustrates examples of a third prefix 2001 (C). In some examples, the third prefix 2001 (C) is an example of an EVEX prefix. The third prefix 2001 (C) is a four-byte prefix.

The third prefix 2001 (C) can encode 32 vector registers (e.g., 128-bit, 256-bit, and 512-bit registers) in 64-bit mode. In some examples, instructions that utilize a writemask/opmask (see discussion of registers in a previous figure, such as FIG. 19) or predication utilize this prefix. Opmask register allow for conditional processing or selection control. Opmask instructions, whose source/destination operands are opmask registers and treat the content of an opmask register as a single value, are encoded using the second prefix 2001 (B).

The third prefix 2001 (C) may encode functionality that is specific to instruction classes (e.g., a packed instruction with “loadtop” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 2001 (C) is a format field 2511 that has a value, in one example, of 62H. Subsequent bytes are referred to as payload bytes 2515-2519 and collectively form a 24-bit value of P [23:0] providing specific capability in the form of one or more fields (detailed herein).

In some examples, P [1:0] of payload byte 2519 are identical to the low two mm bits. P [3:2] are reserved in some examples. Bit P [4] (R′) allows access to the high 16 vector register set when combined with P [7] and the MOD R/M reg field 2144. P [6] can also provide access to a high 16 vector register when SIB-type addressing is not needed. P [7:5] consist of R. X, and B which are operand specifier modifier bits for vector register, general purpose register, memory addressing and allow access to the next set of 8 registers beyond the low 8 registers when combined with the MOD R/M register field 2144 and MOD R/M R/M field 2146. P [9:8] provide opcode extensionality equivalent to some legacy prefixes (e.g., 00=no prefix, 01=66H, 10=F3H, and 11=F2H). P [10] in some examples is a fixed value of 1. P [14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P [15] is similar to W of the first prefix 2001 (A) and second prefix 2011 (B) and may serve as an opcode extension bit or operand size promotion.

P [18:16] specify the index of a register in the opmask (writemask) registers (e.g., writemask/predicate registers 1915). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P [19] can be combined with P [14:11] to encode a second source vector register in a non-destructive source syntax which can access an upper 16 vector registers using P [19]. P [20] encodes multiple functionalities, which differs across different classes of instructions and can affect the meaning of the vector length/rounding control specifier field (P [22:21]). P [23] indicates support for merging-writemasking (e.g., when set to 0) or support for zeroing and merging-writemasking (e.g., when set to 1).

Example examples of encoding of registers in instructions using the third prefix 2001 (C) are detailed in the following tables.

TABLE 1
32-Register Support in 64-bit Mode

| | | | | REG. | COMMON |
|---|---|---|---|---|---|
| | 4 | 3 | [2:0] | TYPE | USAGES |
| REG | R′ | R | MOD R/M reg | GPR, | Destination |
| | | | | Vector | or Source |
| VVVV | V′ | vvvv | | GPR, | 2nd Source or |
| | | | | Vector | Destination |
| RM | X | B | MOD R/M R/M | GPR, | 1st Source or |
| | | | | Vector | Destination |
| BASE | 0 | B | MOD R/M R/M | GPR | Memory |
| | | | | | addressing |
| INDEX | 0 | X | SIB.index | GPR | Memory |
| | | | | | addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 26 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 26 shows a program in a high-level language 2602 may be compiled using a first ISA compiler 2604 to generate first ISA binary code 2606 that may be natively executed by a processor with at least one first ISA core 2616. The processor with at least one first ISA core 2616 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2604 represents a compiler that is operable to generate first ISA binary code 2606 (e.g., object code) that can, with or without additional linkage processing, be executed on the processor with at least one first ISA core 2616. Similarly, FIG. 26 shows the program in the high-level language 2602 may be compiled using an alternative ISA compiler 2608 to generate alternative ISA binary code 2610 that may be natively executed by a processor without a first ISA core 2614. The instruction converter 2612 is used to convert the first ISA binary code 2606 into code that may be natively executed by the processor without a first ISA core 2614. This converted code is not necessarily to be the same as the alternative ISA binary code 2610; however, the converted code will accomplish the general operation and be made up of instructions from the alternative ISA. Thus, the instruction converter 2612 represents software, firmware, hardware, or a combination thereof that, through emulation, simulation or any other process, allows a processor or other electronic device that does not have a first ISA processor or core to execute the first ISA binary code 2606.

Components, features, and details described for any of FIGS. 3-7 may also optionally apply to any of FIGS. 2, 8, and 9. Components, features, and details described for any of the apparatus disclosed herein (e.g., that of FIG. 2) may optionally apply to any of the methods disclosed herein (e.g., 830, 940), which in embodiments may optionally be performed by and/or with such processors. Any of the apparatus described herein (that of FIG. 2) in embodiments may optionally be included in any of the systems disclosed herein. In addition, any of the instructions disclosed herein may in some embodiments optionally have any of the features or details of the instruction formats shown herein.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have be used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but yet still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical or other form of propagated signals-such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth in order to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail in order to avoid obscuring the understanding of the description.

### EXAMPLE EMBODIMENTS

The following examples pertain to further embodiments. Specifics in the examples may be used anywhere in one or more embodiments.

Example 1 is an apparatus including decoder circuitry to decode an instruction. The instruction is to indicate at least one source floating-point vector, a destination storage location, and at least one value. The source floating-point vector is to have a plurality of floating-point data elements. The at least one value is to indicate at least one of: (a) a number of significand bits of the floating-point data elements; (b) a number of exponent bits of the floating-point data elements; (c) exponent bias information for the floating-point data elements; or (d) any combination thereof. The apparatus also includes execution circuitry coupled with the decoder circuitry to perform operations according to the instruction The operations include to interpret the floating-point data elements consistent with the at least one value, perform an operation specified by the instruction on the at least one source floating-point vector to generate a result floating-point vector, and store the result floating-point vector in the destination storage location.

Example 2 includes the apparatus of Example 1, in which the at least one value is to indicate at least the exponent bias information.

Example 3 includes the apparatus of any one of Examples 1 to 2, in which the exponent bias information is either an exponent bias or an exponent bias offset.

Example 4 includes the apparatus of any one of Examples 1 to 3, in which one of: (a) the floating-point data elements are 16-bit floating-point data elements, having five exponent bits, and ten explicit significand bits, and the exponent bias information is to indicate an exponent bias to be used for the floating-point data elements that is not fifteen; (b) the floating-point data elements are 16-bit floating-point data elements, having eight exponent bits, and seven explicit significand bits, and the exponent bias information is to indicate an exponent bias to be used for the floating-point data elements that is not one hundred twenty seven; (c) the floating-point data elements are 8-bit floating-point data elements, having five exponent bits, and two explicit significand bits, and the exponent bias information is to indicate an exponent bias to be used for the floating-point data elements that is not fifteen; and (d) the floating-point data elements are 8-bit floating-point data elements, having four exponent bits, and three explicit significand bits, and the exponent bias information is to indicate an exponent bias to be used for the floating-point data elements that is not seven.

Example 5 includes the apparatus of any one of Examples 1 to 4, in which the exponent bias information is allowed to indicate any one of at least several, at least five, or at least ten different exponent biases to be used for the floating-point data elements.

Example 6 includes the apparatus of Example 1, in which the at least one value includes a first value of at least two, three, or four bits and a second value of at least two, three, or four bits, and optionally in which the first value and the second value are to indicate at least any two of: (a) a number of significand bits of the floating-point data elements; (b) a number of exponent bits of the floating-point data elements; (c) a number of bits of the floating-point data elements; or (d) any combination thereof.

Example 7 includes the apparatus of Example 6, in which the floating-point data elements are 16-bit floating-point data elements, and in which the first and second values are able to specify that the 16-bit floating-point data elements have any one of 3, 4, 5, 6, 7, 8, 9, or 10 exponent bits.

Example 8 includes the apparatus of Example 6, in which the floating-point data elements are 8-bit floating-point data elements, and in which the first and second values are able to specify that the 8-bit floating-point data elements have any one of 3, 4, 5, or 6 exponent bits.

Example 9 includes the apparatus of Example 1, in which the at least one value includes a first value, a second value, and a third value, and optionally in which the first, second, and third values are to indicate at least any three of: (a) a number of significand bits of the floating-point data elements; (b) a number of exponent bits of the floating-point data elements; (c) exponent bias information for the floating-point data elements; (d) a number of bits of the floating-point data elements; or (e) any combination thereof.

Example 10 includes the apparatus of any one of Examples 1 to 9, in which the at least one value is not part of an opcode of the instruction, and in which the at least one value includes at least four bits.

Example 11 includes the apparatus of any one of Examples 1 to 10, further including a general-purpose register to store the at least one value, and in which the instruction is to indicate the general-purpose register.

Example 12 includes the apparatus of any one of Examples 1 to 10, further including a floating-point control register to store the at least one value.

Example 13 includes the apparatus of any one of Examples 1 to 9, in which the at least one value is part of an immediate.

Example 14 includes the apparatus of any one of Examples 1 to 13, in which the instruction is an add instruction, and optionally in which the at least one source floating-point vector includes a first source floating-point vector that is to have the plurality of floating-point data elements and a second source floating-point vector that is to have a plurality of floating-point data elements, and optionally in which the execution circuitry, to perform the operation specified by the instruction on the at least one source floating-point vector, is to add corresponding floating-point data elements of the first and second source floating-point vectors to generate the result floating-point vector.

Example 15 includes the apparatus of any one of Examples 1 to 13, in which the instruction is a floating-point conversion instruction, optionally in which the at least one source floating-point vector includes a single source floating-point vector that is to have the plurality of floating-point data elements, and optionally in which the execution circuitry, to perform the operation specified by the instruction on the at least one source floating-point vector, is to convert the floating-point data elements of the single source floating-point vector to one of double precision, single precision, half precision, bfloat16, FP8 E5M2, or FP8 E4M3 floating-point data elements of the result floating-point vector.

Example 16 is a method including decoding an instruction. The instruction indicating at least one source floating-point vector, a destination storage location, and at least one value. The source floating-point vector having a plurality of floating-point data elements. The at least one value indicating at least one of: (a) a number of significand bits of the floating-point data elements; (b) a number of exponent bits of the floating-point data elements; (c) exponent bias information for the floating-point data elements; or (d) any combination thereof. The method also includes performing operations according to the instruction. The operations include interpreting the floating-point data elements consistent with the at least one value, performing an operation specified by the instruction on the at least one source floating-point vector to generate a result floating-point vector, and storing the result floating-point vector in the destination storage location.

Example 17 includes the method of Example 16, in which the at least one value is to indicate at least the exponent bias information, and optionally in which the exponent bias information is either to explicitly specify an exponent bias or an exponent bias offset.

Example 18 includes the method of Example 16, in which the at least one value includes a first value of at least three bits and a second value of at least three bits, and optionally in which the first value and the second value are to indicate at least any two of: (a) a number of significand bits of the floating-point data elements; (b) a number of exponent bits of the floating-point data elements; (c) a number of bits of the floating-point data elements; or (d) any combination thereof.

Example 19 is a system including an interconnect and a processor coupled with the interconnect. The processor is to receive an instruction. The instruction is to indicate at least one source floating-point vector, a destination storage location, and at least one value. The source floating-point vector is to have a plurality of floating-point data elements. The at least one value is to indicate at least one of: (a) a number of significand bits of the floating-point data elements; (b) a number of exponent bits of the floating-point data elements; (c) exponent bias information for the floating-point data elements; or (d) any combination thereof. The processor is to perform operations according to the instruction. The operations include to interpret the floating-point data elements consistent with the at least one value, perform an operation specified by the instruction on the at least one source floating-point vector to generate a result floating-point vector, and store the result floating-point vector in the destination storage location. The system also includes a dynamic random access memory (DRAM) coupled with the interconnect.

Example 20 includes the system of Example 19, in which the at least one value is to indicate at least the exponent bias information, and optionally in which the exponent bias information is either to explicitly specify an exponent bias or an exponent bias offset.

Example 21 is a processor or other apparatus operative to perform the method of any one of Examples 16 to 18.

Example 22 is a processor or other apparatus that includes means for performing the method of any one of Examples 16 to 18.

Example 23 is a processor or other apparatus that includes any combination of modules and/or units and/or logic and/or circuitry and/or means operative to perform the method of any one of Examples 16 to 18.

Example 24 is an optionally non-transitory and/or tangible machine-readable medium, which optionally stores or otherwise provides instructions including a first instruction, the first instruction if and/or when executed by a processor, computer system, electronic device, or other machine, is operative to cause the machine to perform the method of any one of Examples 16 to 18.

What is claimed is:

1. An apparatus comprising:
decoder circuitry to decode an instruction, the instruction to indicate at least one source floating-point vector, a destination storage location, and at least one value, the source floating-point vector to have a plurality of floating-point data elements, the at least one value to indicate at least one of: (a) a number of significand bits of the floating-point data elements; (b) a number of exponent bits of the floating-point data elements; (c) exponent bias information for the floating-point data elements; or (d) any combination thereof; and
execution circuitry coupled with the decoder circuitry, the execution circuitry to perform operations according to the instruction, including to:
interpret the floating-point data elements consistent with the at least one value;
perform an operation specified by the instruction on the at least one source floating-point vector to generate a result floating-point vector; and
store the result floating-point vector in the destination storage location.

2. The apparatus of claim 1, wherein the at least one value is to indicate at least the exponent bias information.

3. The apparatus of claim 2, wherein the exponent bias information is either an exponent bias or an exponent bias offset.

4. The apparatus of claim 2, wherein one of:
the floating-point data elements are 16-bit floating-point data elements, having five exponent bits, and ten explicit significand bits, and the exponent bias information is to indicate an exponent bias to be used for the floating-point data elements that is not fifteen;
the floating-point data elements are 16-bit floating-point data elements, having eight exponent bits, and seven explicit significand bits, and the exponent bias information is to indicate an exponent bias to be used for the floating-point data elements that is not one hundred twenty seven;
the floating-point data elements are 8-bit floating-point data elements, having five exponent bits, and two explicit significand bits, and the exponent bias information is to indicate an exponent bias to be used for the floating-point data elements that is not fifteen; and
the floating-point data elements are 8-bit floating-point data elements, having four exponent bits, and three explicit significand bits, and the exponent bias information is to indicate an exponent bias to be used for the floating-point data elements that is not seven.

5. The apparatus of claim 2, wherein the exponent bias information is allowed to indicate any one of several different exponent biases to be used for the floating-point data elements.

6. The apparatus of claim 1, wherein the at least one value includes a first value of at least three bits and a second value of at least three bits, and wherein the first value and the second value are to indicate at least any two of: (a) a number of significand bits of the floating-point data elements; (b) a number of exponent bits of the floating-point data elements; (c) a number of bits of the floating-point data elements; or (d) any combination thereof.

7. The apparatus of claim 6, wherein the floating-point data elements are 16-bit floating-point data elements, and wherein the first and second values are able to specify that the 16-bit floating-point data elements have any one of 3, 4, 5, 6, 7, 8, 9, or 10 exponent bits.

8. The apparatus of claim 6, wherein the floating-point data elements are 8-bit floating-point data elements, and wherein the first and second values are able to specify that the 8-bit floating-point data elements have any one of 3, 4, 5, or 6 exponent bits.

9. The apparatus of claim 1, wherein the at least one value includes a first value, a second value, and a third value, and wherein the first, second, and third values are to indicate at least any three of: (a) a number of significand bits of the floating-point data elements; (b) a number of exponent bits of the floating-point data elements; (c) exponent bias information for the floating-point data elements; (d) a number of bits of the floating-point data elements; or (e) any combination thereof.

10. The apparatus of claim 1, wherein the at least one value is not part of an opcode of the instruction, and wherein the at least one value comprises at least four bits.

11. The apparatus of claim 1, further comprising a general-purpose register to store the at least one value, and wherein the instruction is to indicate the general-purpose register.

12. The apparatus of claim 1, further comprising a floating-point control register to store the at least one value.

13. The apparatus of claim 1, wherein the at least one value is part of an immediate.

14. The apparatus of claim 1, wherein the instruction is an add instruction, wherein the at least one source floating-point vector includes a first source floating-point vector that is to have the plurality of floating-point data elements and a second source floating-point vector that is to have a plurality of floating-point data elements, and wherein the execution circuitry, to perform the operation specified by the instruction on the at least one source floating-point vector, is to add corresponding floating-point data elements of the first and second source floating-point vectors to generate the result floating-point vector.

15. The apparatus of claim 1, wherein the instruction is a floating-point conversion instruction, wherein the at least one source floating-point vector includes a single source floating-point vector that is to have the plurality of floating-point data elements, and wherein the execution circuitry, to perform the operation specified by the instruction on the at least one source floating-point vector, is to convert the floating-point data elements of the single source floating-point vector to one of double precision, single precision, half precision, bfloat16, FP8 E5M2, or FP8 E4M3 floating-point data elements of the result floating-point vector.

16. A method comprising:
decoding an instruction, the instruction indicating at least one source floating-point vector, a destination storage location, and at least one value, the source floating-point vector having a plurality of floating-point data elements, the at least one value indicating at least one of: (a) a number of significand bits of the floating-point data elements; (b) a number of exponent bits of the floating-point data elements; (c) exponent bias information for the floating-point data elements; or (d) any combination thereof; and
performing operations according to the instruction, including:
interpreting the floating-point data elements consistent with the at least one value;
performing an operation specified by the instruction on the at least one source floating-point vector to generate a result floating-point vector; and
storing the result floating-point vector in the destination storage location.

17. The method of claim 16, wherein the at least one value is to indicate at least the exponent bias information, and wherein the exponent bias information is either to explicitly specify an exponent bias or an exponent bias offset.

18. The method of claim 16, wherein the at least one value includes a first value of at least three bits and a second value of at least three bits, and wherein the first value and the second value are to indicate at least any two of: (a) a number of significand bits of the floating-point data elements; (b) a number of exponent bits of the floating-point data elements; (c) a number of bits of the floating-point data elements; or (d) any combination thereof.

19. A system comprising:
an interconnect;
a processor coupled with the interconnect, the processor to receive an instruction, the instruction to indicate at least one source floating-point vector, a destination storage location, and at least one value, the source floating-point vector to have a plurality of floating-point data elements, the at least one value to indicate at least one of (a) a number of significand bits of the floating-point data elements, (b) a number of exponent bits of the floating-point data elements, (c) exponent bias information for the floating-point data elements, or (d) any combination thereof, the processor to perform operations according to the instruction, including to:
interpret the floating-point data elements consistent with the at least one value;
perform an operation specified by the instruction on the at least one source floating-point vector to generate a result floating-point vector; and
store the result floating-point vector in the destination storage location; and
a dynamic random access memory (DRAM) coupled with the interconnect.

20. The system of claim 19, wherein the at least one value is to indicate at least the exponent bias information, and wherein the exponent bias information is either to explicitly specify an exponent bias or an exponent bias offset.
